(19) United States
(12) Patent Application Publication
(10) Pub. No.: US 2025/0319842 A1
(43) Pub. Date: Oct. 16, 2025

(54) REMOTE VEHICLE BATTERY DISCONNECT SYSTEM

(71) Applicant: SafeLot LTD, Spokane, WA (US)

(72) Inventors: Darren C. Murray, Colbert, WA (US); Shae C. Murray, Mead, WA (US)

(21) Appl. No.: 19/174,575

(22) Filed: Apr. 9, 2025

Related U.S. Application Data
(60) Provisional application No. 63/633,313, filed on Apr. 12, 2024.

(51) Int. Cl. B60R 25/045; B60R 25/102; B60R 25/24

(52) U.S. Cl. CPC B60R 25/045; B60R 25/102; B60R 25/24

(57) ABSTRACT

A theft deterrent device configured to facilitate remote disconnection of a power supply from a powertrain of one or more vehicles may be coupled to an ignition circuit of a vehicle and may comprise a transceiver configured to send and receive data. Vehicle(s) may be grouped by myriad criteria data (which a user may define in an associated smartphone application) and may be remotely enabled/disabled based on each vehicles' association with the criteria data (membership in the group defined by criteria data). For example, based on a vehicles attribute data (e.g., lot number, VIN number, geolocation), the techniques herein may be configured to remotely enable/disable the vehicle by engaging a switch to close/interrupt an ignition circuit of the vehicle.

### CROSS-REFERENCE TO RELATED APPLICATION

This patent application is a non-provisional of and claims priority to U.S. Provisional Patent Application No. 63,633,313, filed Apr. 12, 2024, which is hereby incorporated by reference in its entirety and for all purposes.

### BACKGROUND

After market theft deterrent devices exist that can be attached to a vehicle to deter theft. For example, some conventional theft deterrent devices include a disconnect switch that is designed to disconnect the vehicle's engine starter from power that is supplied by a battery when the vehicle is not in use by an authorized user of the vehicle. However, such conventional theft deterrent devices provide limited functionality.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIGS. 1A and 1B illustrate example disconnect devices in the context of a power supply in accordance with one or more implementations of the disclosure.

FIG. 2 illustrates an example disconnect device in accordance with one or more implementations of the disclosure.

FIG. 3 depicts a block diagram of an example system for implementing various techniques described herein.

FIG. 4 depicts a block diagram of an example system configured to implement the techniques discussed herein.

FIG. 5 illustrates a block diagram of an example device configured to implement the techniques discussed herein.

FIGS. 6A and 6B depict an example flow diagram configured to implement the one or more of the techniques discussed herein as may be presented to a user on a network device.

FIGS. 7A and 7B depict an example flow diagram configured to implement the one or more of the techniques discussed herein as may be presented to a user on a network device.

FIG. 8 depicts example interfaces configured to implement one or more of the techniques herein, as may be presented to a user via a network device.

FIGS. 9A and 9B depict example interfaces configured to implement one or more of the techniques herein, as may be presented to a user via a network device.

FIG. 10 depicts an example workflow diagram for a system configured to implement one or more techniques discussed herein.

### DETAILED DESCRIPTION

This application claims priority to U.S. Provisional Patent Application 63/633,313, filed Apr. 12, 2024, titled “REMOTE VEHICLE BATTERY DISCONNECT,” which is hereby incorporated by reference in its entirety and for all purposes.

As discussed above, conventional aftermarket vehicle theft deterrent systems have limited functionality. For example, they may be difficult or inconvenient to use, may be easily circumvented by a thief or malicious actor, may be designed for use for a single vehicle as opposed to being used to control and secure a fleet of vehicles, may cause electronics of the vehicle to be disconnected from power and lose their settings, and so on. For example, conventional vehicle theft deterrent devices may not efficiently or effectively facilitate use by a car dealership or other owner or operator of a fleet of vehicles. This application describes theft deterrent devices and systems that are easy to use, difficult to circumvent, and are scalable to control and secure multiple vehicles in a coordinated manner, such as an inventory of vehicles of a car dealership or operator of a fleet of vehicles.

Some conventional vehicle theft deterrent systems include a disconnect device coupled to a fuse box of a vehicle to disconnect power to an ignition system of the vehicle to prevent the vehicle from being started. However, such systems may be easily circumvented, their use may damage or permanently alter one or more components or systems of the vehicle and/or may void a vehicle warranty. The devices and systems described herein are difficult to be circumvented, may be installed or otherwise implemented on a vehicle without damaging or permanently altering the vehicle, and without voiding a vehicle manufacturer's warranty.

In some examples, a battery or other power supply may provide a useful location to disable the vehicle because of its importance in supplying power to a powertrain of the vehicle and/or for its accessibility to a seller or end user of the vehicle. In at least some examples, the techniques described herein may be applied to vehicles having a variety of different powertrains, including internal combustion engines, hybrid powertrains, electric motors, or other combinations or variations thereof. Also, the techniques described herein may be applied to a wide variety of different types of vehicles, such as, for example, passenger vehicles (e.g., cars, trucks, vans, motorcycles, etc.), construction equipment, aircraft, boats, drones, all-terrain vehicles (ATVs), motorized bicycles, recreational vehicles (RVs), golf carts, etc.

The techniques (e.g., hardware, software, a combination thereof) discussed herein may comprise a remotely controlled power supply disconnect system, method, and/or device that may be used by one or more owners or operators of one or more vehicles to disrupt the power from a power supply (e.g., battery, capacitor, fuel cell, etc.) to a powertrain (e.g., an engine, starter/ignition system, electric motor, etc.) or other component of a vehicle. In some examples, the techniques may be applied to multiple individual vehicles in a collection of vehicles (e.g., a fleet or inventory of vehicles) and may be used to disable, manage, or otherwise control the power supplied to multiple vehicles individually, collectively, or in groups (e.g., by type, location, manual grouping, or any other grouping criteria (e.g., one or more criterion), discussed in more detail below).

While many of the examples of this disclosure are given in the context of vehicles including an internal combustion engine (including hybrid powertrains), the techniques described herein may be adapted to perform the same or similar functions on an electric vehicle or other vehicle that may lack an ignition or starter. Additionally, while may of the examples of this disclosure are given in the context of an aftermarket hardware device that is applied to the vehicle after it is manufactured, in other examples, the techniques described may be implemented by a manufacturer during assembly or prior to introduction in a market. In other examples, the techniques may be integrated into vehicle system(s) or component(s) by updating the software or firmware of a vehicle to implement the functionality described herein without the need for an additional hardware device. In other words, in some examples, the techniques, methods, and processes may be integrated into existing vehicle(s) via a software or firmware update, without the addition or installation of a separate device.

The techniques of this disclosure facilitate an improved manner of remotely controlling an electrical circuit between the power supply and a powertrain of one or more vehicles. Such techniques may be useful to prevent theft from or unauthorized tampering with the vehicle(s) in a lot of a dealership, for example. In such an example, one or more owners or operators may disrupt the power supplied to a powertrain based on myriad conditions, one or more criterion, or factors, discussed in more detail below. Doing so may deter potential thieves, reduce or eliminate unintended battery discharge, and/or otherwise protect or maintain a fleet of one or more vehicles. In another example, an owner of a vehicle may install a disconnect device to a vehicle that they use intermittently or rarely. Doing so may prevent unintended battery discharge (e.g., due to faulty wiring, extreme temperatures, an old battery, etc.). Doing so may enhance the security and safety of the vehicle by isolating a battery in the event of an emergency. Other benefits are contemplated herein, and one of ordinary skill in the art will understand and appreciate the myriad use cases, benefits, and desirable traits of the techniques and devices of this disclosure.

It should be noted that although many of the examples and use cases discussed in this disclosure are in the context of an individual vehicle, any reference to a “vehicle” is for purposes of clarity and any of the techniques discussed may be applied to a plurality of vehicles.

In some examples, a theft deterrent device may be coupled to a negative terminal of a vehicle battery and may comprise a switch configured to be remotely controlled to selectively open and close a circuit from the vehicle battery and a starter or ignition of the vehicle. When the circuit is closed, the vehicle may operate nominally (e.g., starting and operating the vehicle may not be interrupted or disabled). When the circuit is open, the vehicle may be disabled by withholding power from the vehicle starter or ignition.

In some examples, the theft deterrent device may further comprise a transceiver that may be configured to send and/or receive information (e.g., data, instructions, and/or other signals). The transceiver may be wireless or be capable of being wired to one or more separate devices to facilitate the exchange of the information. In some examples, the transceiver may be capable of sending/receiving information over one or more communication channels or protocols (e.g., cellular, wireless fidelity (Wi-Fi), Bluetooth, Zigbee, near field communication (NFC), other radio frequency (RF), ultrasonic communication channels, and so on).

In examples, the transceiver may send and/or receive the data to/from one or more network devices (e.g., a mobile device, tablet, personal computer, server, cloud computing resource, vehicle electronic control unit or other vehicle computing devices, etc.) associated via the communication protocol. “Network device(s)” is used herein to denote any device or system that is capable of processing data/information and transmitting and receiving data over network(s). In some instances, network device(s) may comprise storage, one or more processors, and/or memory storing processor executable instructions configured to be implemented by the processors to carry out the techniques discussed herein. Some network device(s) comprise user interface(s) (e.g., touchscreens, keyboards, voice controls) to facilitate user interaction. As a few nonlimiting examples for purposes of clarity and not limitation, network device(s) may comprise smartphones, tablets, personal laptop computers, desktop computers, and so on.

In some examples, network device(s) may be associated with user(s) or operator(s). The data may be transmitted directly from the theft deterrent device to network device associated with a user (e.g., in a peer-to-peer manner) or may be transmitted via one or more intermediary networks and devices (e.g., a backend server or cloud computing device). An intermediary network may host a theft deterrent device management system (e.g., an inventory) or may be responsible for operating a vehicle fleet management system.

In examples, one or more users of the network device(s) may have a specified or relative level of authority, as discussed in more detail below. The level of authority may allow or disallow an individual or network device to send data to a transceiver of theft deterrent device(s) coupled to battery terminals of one or more vehicles. The theft deterrent device(s) may then disconnect, based on that disconnect data from the individual or network device, power to the vehicle(s), thereby disabling their operation. As a more concrete example, a manager of a car dealership may send data (e.g., a disconnect signal) via an application on a network device (e.g., mobile smartphone device, computer, tablet) to one or more vehicles in or associated with the manager's dealership lot when the car dealership closes for the evening. In the same example, an associate or car salesperson may not be similarly able to disable the vehicle(s) at least in part because of their level of authority. Relatedly, the associate or salesperson may not have the requisite level of authority to define criteria (e.g., location, time of day, identification number(s)) used to define a group vehicle(s) and/or to disable the group of vehicles.

In some examples, the network device(s) may determine a communication protocol that may be used to send and/or receive information from a transceiver of one or more theft deterrent devices. Determining the communication protocol may be based on myriad factors, including but not limited to a distance between one or more vehicles and the network device (e.g., cellular may be better suited for longer distances than Bluetooth), a latency, a network connectivity of one or more of the vehicles or the network device (e.g., a vehicle is in a warehouse and does not have network connectivity to send/receive data), a subscription (e.g., one or more users may subscribe to or activate cellular capabilities of the theft deterrent device), or one or more preference settings (e.g., ultrasonic signals may be better suited to a specific set of conditions in an environment, and a user may accordingly designate ultrasonic signaling as their preferred communication protocol). There may be additional or alternative considerations or factors that affect which communication protocol is preferred. Any of those mentioned herein may be used individually or in combination with others to provide the most effective and/or efficient communication protocol for sending and/or receiving signals and/or information.

In some examples, one or more users may send a disconnect or connect signal to one vehicle rather than a plurality of vehicles. Such may be the case, for example, if a vehicle owner wants to disconnect the circuit from the battery to the powertrain to disable their vehicle while they are on vacation. In another example, a car dealership salesperson may transmit a connect signal to a transceiver of a theft deterrent device to connect power to the powertrain, thereby enabling the vehicle for a test drive.

Additionally or alternatively, a user may specify a collection (e.g., subset or group) of vehicles that they wish to disable by engaging the theft deterrent device to thereby disconnect/disrupt power to the powertrain. In some examples, a network device may receive first data (e.g., user input data) associated with one or more user specified criterion. The network device may then determine, based at least in part on the one or more user specified criterion and attributes associated with vehicle(s) in a fleet, a collection of vehicles that satisfy the criterion.

Additionally or alternatively, the network device may determine which vehicle(s) in a fleet or in a collection the user has authority to control. For example, the network device may determine vehicles that are owned by the user, are associated with a particular car dealership, are associated with a particular business or entity. In other examples, the network device may determine vehicle(s) over which the user has custody (e.g., in the case of a storage facility or shipping company), or all of those vehicles for which a user is responsible (e.g., in the case of a dealership or rental lot manager).

As a more concrete example, a manager at a car dealership may specify a geographical radius of one mile around the employer's car lot, and the network device may determine a collection of vehicles owned by the manager that satisfy the criteria (e.g., that are within one mile from the car lot). Such a collection may be based on myriad factors or conditions that a user may specify as criterion. As an additional nonlimiting example, a user may define the criterion for a collection of one or more vehicles based at least in part on one or more of a radius or geolocation (e.g., all theft deterrent device(s) within 1 mile of a dealership warehouse), within one or more predefined or user configurable areas (e.g., geofenced regions, cities, states, etc.), a time of day (e.g., theft deterrent device(s) are set to disconnect at 9:00 pm and are set to connect at 8:00 am), day(s) of the week (e.g., theft deterrent device(s) disconnect on Saturdays and Sundays). In other examples, criterion may be defined based on a manufacturer (e.g., all vehicles made by BMW), a year or range of years (all 2023 or newer vehicles), a model (e.g., all sedans, all trucks, etc.), a price range (e.g., all vehicles over a certain price), a vehicle identifier (e.g., a vehicle identification number (VIN), license plate sequence or color, unique identifier from a retrievable database), a defined or configured fleet of vehicles (e.g., a dealer manager can determine/define a set of vehicles manually), a timeframe (e.g., an individual wants to disable a set of vehicles between two specified dates while they are away from home or between two times while they are asleep or at work). In some examples, a user may manually select, indicate, or otherwise specify which vehicle(s) belong to the collection. For example, from a user device, a user may select or indicate (e.g., manually or individually) a plurality of individual vehicles that they wish to add to the collection. Each of these conditions/factors may be used individually or in combination with others or may be combined in myriad ways to best suit a user's preferences. Further, this list is non-exhaustive, and more conditions/factors are contemplated herein. One or ordinary skill in the art will understand and appreciate the myriad criterion that may be applied individually or in combination to enable/disable vehicle(s) to suit their preferences.

In some examples, a collection of vehicle(s) may be defined by one or more groups of vehicles owned and/or managed by a vehicle dealer that are spread across multiple locations. In such an example, the vehicle dealer may define criterion for a collection of vehicle(s) that span across geographies or locations, thereby allowing them to manage vehicles at one or more vehicle lots in different locations. As a more concrete example, a regional manager of a vehicle dealer may define the criterion for the collection of vehicles by specifying a first plurality of vehicles in a first city and a second plurality of vehicles in the same or a different city. In other words, the techniques discussed herein may be applied to a set of vehicles comprising a first collection of one or more vehicles located in a first location and a second collection of one or more vehicles located in a second location different than the first location.

In some examples, a network device may additionally or alternatively receive authentication data associated with one or more users. The authentication data may be used to ensure that only users that have permission/authority to disable, manage, or otherwise control theft deterrent device(s) or fleet(s) of vehicles is able to do so. When a user attempts to access a system (e.g., a fleet management system), the user may be authenticated and based on that authentication, an instruction (e.g., to connect or disconnect) may be transmitted to the theft deterrent device(s). For instance, a user may use personal authentication data (e.g., log in username and password, biometric information, multi-factor authentication techniques, key card/badge) to authenticate themselves with the network device or to transmit the data to the theft deterrent device(s).

In some examples, there may be a single individual associated with a network device configured to control heft deterrent device(s). For example, an individual user may operate a single theft deterrent device associated with their only vehicle. In another example, an individual user may be associated with a network device configured to operate multiple theft deterrent device(s) coupled to a plurality of vehicles that they own (e.g., a commuter and a lawn mower tractor).

In other examples, there may be a plurality of users associated with a single account or network device. For example, multiple employees of a vehicle dealership may each have their own personal account on their network device(s), and each personal account may be associated with a dealership entity account. In another example, all members of a family may have a personal account that are each associated with a family entity account.

In some examples, users may be separated into a hierarchy of permissions or authority. Different levels of permission or authority may dictate a user's ability to transmit data or instructions, and/or to set or alter criteria used to define collection(s) of vehicle(s). For example, a lower-level employee or user may have fewer permissions or reduced authority to control transmission of data and/or instructions to theft deterrent device(s). On the other hand, a higher-level or managerial employee may be granted greater permissions and may have increased authority to control transmission of data and/or instructions to theft deterrent device(s). As a more concrete example, if a vehicle mechanic employed by a vehicle dealer attempts to send a disconnect instruction to disable a collection of vehicles, the network device may first request that the mechanic authenticate themselves before the network device transmits the disconnect instruction. The mechanic may only have authority to disable or reenable a single vehicle at a time and may not be able to validly transmit a disconnect instruction to the collection of vehicles. In examples, the mechanic may request permission from a service manager or lot manager before being authorized to disable the collection of vehicles. In another example, a notification may be sent to a supervisor or other user when the mechanic disables or enables (e.g., deactivates or activates an ignition switch) a vehicle or a collection of vehicles.

Additionally or alternatively, a regional manager of a vehicle dealer may validly authenticate themselves with the network device based at least in part on their permissions and/or level of authority. Based on valid authentication, the regional manager may then cause the network device to transmit the data and/or disconnect instruction.

In another concrete example, a head-of-household may hold the greatest authority for a fleet of one or more vehicles owned or controlled by their family, and a teenager may hold few or no permissions or authority to transmit and/or receive data or instructions to vehicle(s) in the fleet. In such an example, the head-of-household may be the only individual with the requisite authority to transmit and/or receive information and/or instructions to/from one or more vehicles. Additionally or alternatively, the head-of-household may be the only user (or, e.g., one of a select few users) with the permissions or authority to define a collection of vehicle(s) to disable/enable by transmitting a signal to the corresponding theft deterrent device(s).

In some examples, two or more users may first authenticate with a network device before the data and/or instruction is transmitted to or received from the theft deterrent device. In other words, in some instances an owner or operator of one or more vehicles may prefer that before information is sent to/from a network device, two or more users each authenticate themselves with the same or separate network devices. Such may be the case, for example, for an especially high-value vehicle, where the owner or operator wants to ensure that a single user is not capable of unilaterally enabling a vehicle. Insisting that two or more users separately authenticate (e.g., simultaneously or within a threshold duration of one another) may improve security by ensuring that at least two people are aware of and individually validate a connect or disconnect instruction. Such an authentication process may be used in combination with any one or more of the other features and components as discussed herein.

In some examples, if a user fails to authenticate themselves one or more times (e.g., a number of authentication attempts that exceeds a threshold number of authentication attempts), the network device may send, based on the failed authentication attempts, data associated with a predetermined duration to theft deterrent device(s). The theft deterrent device(s) that receive the data may then become disabled for the predetermined duration, disallowing any further information or other instructions to be exchanged with theft deterrent device for that duration (e.g., “lock out”). This temporary disabling of the device may help ensure that unauthorized users are not able to brute force guess a password or spoof authentication credentials by introducing a lock out delay. By introducing a delay feature, alleged intruders or misusers of the device and/or system may be temporarily incapable of further use of the system and/or device without a separate valid authentication by a different user or on a different network device. Such a time delay feature may also prevent or deter theft and/or tampering with the system/device by disrupting an attempted abuse or misuse before the vehicle is enabled and maneuverable.

Additionally or alternatively, a network device may receive a notification from the theft deterrent device(s) coupled to vehicle(s) indicating that the theft deterrent device(s) were disconnected, disabled, or otherwise tampered with. In such an example, a theft deterrent device may transmit a notification to network device(s) based at least in part on the theft deterrent device disconnecting or connecting an ignition circuit, or otherwise becoming disabled. As a more concrete example, if a theft deterrent device disconnects an ignition circuit of one or more vehicles, the theft deterrent device may transmit a notification to one or more users and/or network devices that may comprise pertinent information such as what time the theft deterrent device was disconnected, who transmitted the instruction, to which devices/vehicles was the data sent, and so on.

In some examples, a theft deterrent device may additionally or alternatively transmit other data and/or information about the vehicle with which it is associated (e.g., geolocation, data, velocity data, etc.) to a theft deterrent system. In such an example, the theft deterrent device may transmit real time data and/or information to user(s) associated with network device(s) so that the users can track, monitor, or otherwise remain informed as to the location and status of the vehicle(s). The information about the vehicle may be transmitted continuously (e.g., updated or transmitted in real-time), periodically (e.g., every 5 minutes, every hour, etc.), or upon detection of an event or a change of state of the device (e.g., movement of or tampering with the device). For example, the theft deterrent device may transmit location and updated status data based at least in part on an impact detected by an inertial measurement sensor, a change in location detected by a GPS sensor or cellular sensor, a change in power state (e.g., the device is disconnected from the battery of the vehicle), and so on.

As a more concrete example, the theft deterrent device or system may transmit or present real time data (e.g., live) or batch data (e.g., at a predetermined time, when a vehicle returns to a lot) to a manager of a vehicle dealership during or after a vehicle is maneuvered for a test drive. Such data and information may allow a manager to monitor the speed, location, acceleration, collision/incident information, or other pertinent behavior of the vehicle during a test drive or vehicle exchange, for example. In such an example, the data and/or information may be presented to the user(s) at a network device.

In some examples, a network device and/or theft deterrent device may further comprise a manual override feature. The manual override feature may be configured to activate a switch to bypass an authentication procedure and allow a user to connect or disconnect power supplied from the battery terminal of the vehicle to the powertrain of the vehicle. This may be beneficial, for example, in an emergency situation where one or more vehicles are blocking a path of an emergency vehicle and must be urgently relocated. As another concrete example, if, during an emergency, a head-of-household is not available to remotely enable a vehicle, another user may utilize the manual override feature to circumvent one or more of the deterrent features or authentication processes discussed herein to activate an ignition switch (and thereby enable or disable the vehicle). In yet another example, in the event of an electrical short or fire-related emergency, a user who is not authenticated with the device/system may need to disconnect the power supply of the vehicle to mitigate or avoid further damage. In all of the aforementioned situations where time is of the essence, a manual override feature on the network device and/or the theft deterrent device may facilitate a quick and efficient response to the emergency for a user who is unable to authenticate themselves (e.g., because they do not have time, because they are not an authenticated user, etc.).

These and numerous other features, examples, and use cases are described herein below with reference to the figures. The following figures depict illustrative examples of the techniques described herein and are presented for purposes of clarity and not limitation.

### Example Scenario

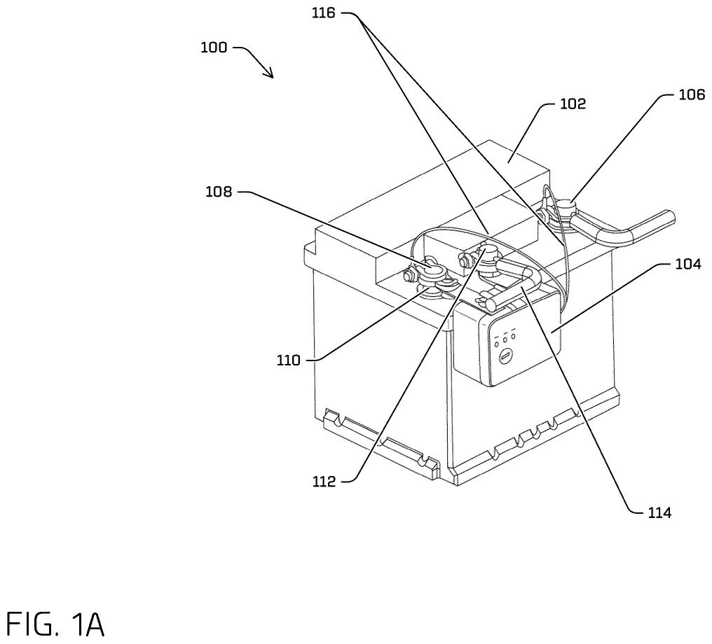

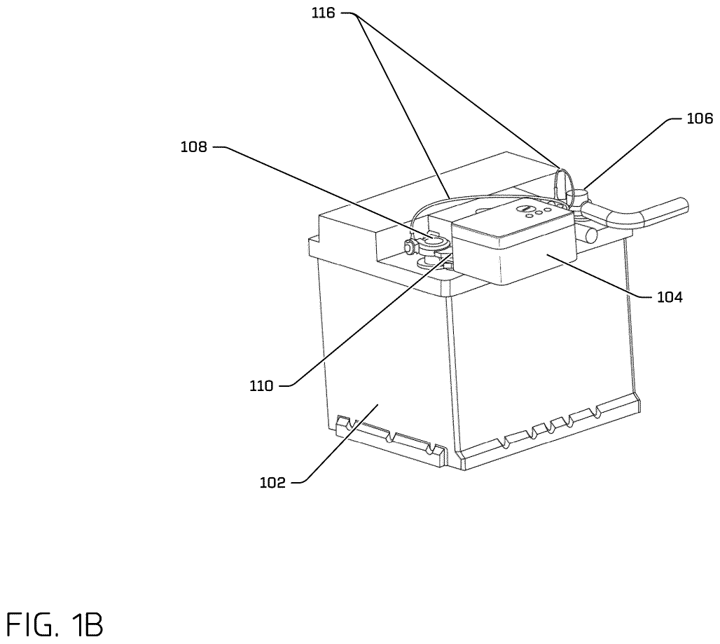

FIG. 1A illustrates an example scenario 100 including a battery 102 and a theft deterrent device 104. The battery 102 is depicted with a positive terminal 106 and a negative terminal 108. In some instances, theft deterrent device 104 may be interposed inline (in series) in an ignition circuit of the vehicle. For example, the theft deterrent device 104 may comprise a first electrical connector 110 configured to connect to a negative post (i.e., negative terminal 108) of the battery 102 and a second electrical connector 112 to which a negative wire 114 of the ignition circuit may be connected. In such a case, a switch disposed on the theft deterrent device 104 may be configured to selectively open and close the ignition circuit, thereby enabling the vehicle ignition when the ignition circuit is closed and disabling the vehicle ignition when the ignition circuit is open.

A theft deterrent device 104 may further comprise a transceiver configured to transmit and/or receive information according to any of the techniques described herein. The theft deterrent device 104 may additionally or alternatively comprise a controller (e.g., controller 508) configured to cause the theft deterrent device 104 to perform any one or more operations discussed herein. For example, the controller may comprise one or more processors and/or a memory storing processor-executable instructions that, when executed by the one or more processors, cause the one or more processors to perform any one or more operations discussed herein. In some examples, the controller may comprise an application specific integrated circuit (ASIC), field programmable gate array (FPGA), microcontroller unit (MCU), system-on-chip (SoC), digital signal processor (DSP), or similar controller unit that may carry out some or all of the processing and/or execution of the operations discussed herein.

In the illustrated example, electronic components (e.g., transceiver, controller, sensors, etc.) of the theft deterrent device 104 may be powered by the battery 102 via a low current power supply lines 116. Although depicted as being disposed exterior to the theft deterrent device 104, one or more of the low current power supply lines 116 may be disposed inside of the housing body of the theft deterrent device 104. The low current power supply lines 116 may comprise a low current rating. A low current rating may be associated with carrying a small amount of electrical current, which may be measured in microamps, milliamps, or amps. For example, the low current supply lines 116 may be configured to carry between 0.000001 A (one microamp) up to 5 amps. In another example, the low current supply lines 116 may comprise a thinner gauge wire (e.g., 24 AWG or otherwise) sufficient to carry relatively low current loads (as compared to higher current loads like home and garage circuit wiring). One of ordinary skill in the art will understand and appreciate the various materials or gauges suitable for the functionality served by the low current supply lines 116, and the examples herein are for purposes of illustration and not limitation.

Additionally or alternatively, the theft deterrent device 104 may include a power supply (e.g., a battery, which is not shown in this figure for purposes of clarity) as either a primary or backup power supply.

In some examples, the first electrical connector 110 and/or the second electrical connector 112 may be configured to continuously supply power supplied from the battery 102 to the theft deterrent device 104 (e.g., via a low current or voltage) during nominal use (e.g., prior to an attempted theft or other unauthorized use of or tampering with the vehicle or theft deterrent device 104). In such an example, the theft deterrent device 104 may maintain a current state while attached to the vehicle until the controller detects a change (e.g., surge or increase) in power supplied to the ignition circuit. The theft deterrent device 104 may, upon detecting the change in power supplied to the ignition circuit, disconnect the switch or otherwise open the ignition circuit so that the vehicle is disabled. In other words, the theft deterrent device 104 may allow various electronic components of the vehicle to receive power supplied from the power supply (e.g., to maintain the clock, radio settings, etc.) unless and until it detects an unauthorized engagement of the ignition system which may indicate that an unauthorized user is attempting to start the vehicle via the ignition. In some examples, maintaining power to electronic components of the vehicle may further allow the vehicle to receive and implement factory updates without interruption. For example, the theft deterrent device 104 may allow the vehicle to continue to receive software or firmware updates from a dealership or factory notwithstanding the status (e.g., engaged or disengaged) of the switch.

In some examples, a network device of the theft deterrent system may send, via a transceiver, a signal (e.g., a disconnect instruction) to control (e.g., engage) the switch of a theft deterrent device 104. The theft deterrent device 104 may then control, based at least in part on the signal from the network device, the switch to open the ignition circuit so that a vehicle is disabled. In such an example, engaging the switch and opening the ignition circuit disconnects the vehicle power supply (e.g., battery 102) from the vehicle ignition, thereby rendering the vehicle inoperable (disabled). In such an example, the signal may comprise instructions or other information. The data may take the form of one or more data packets, analog signals (e.g., voltage, current, amperage), timing signals, control signal, or otherwise.

In examples, the operations may further comprise receiving, via a transceiver of a theft deterrent device 104, criteria data associated with a collection of one or more vehicles. As discussed above, the criteria data that define or determine a collection of one or more vehicles may be based on myriad factors and/or conditions. For example, the criteria data may be user-defined, meaning a user may specify or indicate what factors/conditions/attributes are associated with which vehicles they wish to control/define. In another example, a machine-learned model or other processor/memory mechanism may receive user input and output the criteria data. For example, the user may input an English-language sentence about what they wish to accomplish (e.g., “Disengage the power to all vehicles with an MSRP>$200,000 after 5:00 pm PT and on the weekends”). A machine-learned (ML) model (e.g., large-language model or otherwise) may be trained and configured to receive the user's input and to determine applicable criteria data. Additionally or alternatively, the ML model may have access to an inventory of vehicle(s) associated with an owner or operator and may determine which individual vehicles satisfy the criteria data and thereby comprise the collection of vehicles.

In some examples, the theft deterrent device 104 may further receive, via the transceiver, data associated with a vehicle attribute. In other examples, the theft deterrent device 104 may store or otherwise have access to (e.g., be communicatively coupled to a remote store) attributes associated with the vehicle with which it is associated. Vehicle attributes may generally comprise information or context associated with the vehicle with which a theft deterrent device is associated and may be used to identify the vehicle and/or to determine whether the vehicle is a member of a collection of vehicle(s). Such vehicle attribute(s) may comprise, for example, a geolocation, a manufacturer, a model of the vehicle, a model year of the vehicle, a vehicle identifier (e.g., a VIN number, a license plate number or color, a unique ID from a retrievable database), a date, a time of day (e.g., from the vehicle's internal clock), or otherwise.

In some examples, any one or more vehicle attributes (or criteria data) may be received by the transceiver of the theft deterrent device 104, and the theft deterrent device 104 may then determine, based at least in part on criteria data (e.g., one or more user-defined criterion) and the vehicle attribute(s), that the device is coupled to a vehicle that belongs to the collection of one or more vehicles. In other words, based on criteria data associated with a collection of one or more vehicles and the attribute(s) of the vehicle that the theft deterrent device 104 is associated with, the controller of the theft deterrent device 104 may determine whether the vehicle satisfies the criteria data and is therefore a part of the collection of one or more vehicles. In such an example, the controller may control the switch based at least in part on determining that the theft deterrent device 104 is coupled to or associated with a vehicle that belongs to the collection of one or more vehicles.

As a more concrete nonlimiting example, if a user defines a collection of one or more vehicles that includes all red sedan vehicles within a one-mile radius of a dealership, the theft deterrent device may receive or interpret (e.g., via a controller) various vehicle attributes associated with the color, size, and/or geolocation of the vehicle that the theft deterrent device 104 is coupled to. In such an example, the theft deterrent device 104 may determine, based on the vehicle attributes, whether the vehicle satisfies the criteria and therefore belongs to the collection of one or more vehicles. In such an example, the controller may control the switch based at least in part on that determination, thereby disabling the red sedan-size vehicle located within one mile from the warehouse that the theft deterrent device 104 is associated with.

In another example, the theft deterrent device 104 may have access to a remote store of vehicle attributes or may store the vehicle attributes locally. For example, the theft deterrent device 104 may be communicatively coupled to a remote storage database storing vehicle attributes corresponding to unique identifiers associated with each vehicle with which each theft deterrent device is associated with. In other words, using an identifier (e.g., unique ID, VIN number, etc.), the theft deterrent device 104 may retrieve the vehicle attributes associated with the vehicle with which it is coupled to.

In another example, the theft deterrent device 104 may store locally the vehicle attributes associated with the vehicle to which it coupled. The vehicle attributes may be defined or input by a user upon installation of the theft deterrent device 104, and/or may be configured or updated via a software update.

Additionally or alternatively, a controller of a theft deterrent device 104 may perform operations comprising sending (or, e.g., causing to be sent via a transceiver), a notification to one or more remote network devices that may be communicatively coupled to the transceiver. The notification may indicate that the switch of the theft deterrent device 104 was engaged, or that the theft deterrent device 104 was tampered with, bumped, jostled, or otherwise manipulated. As discussed above, a user may want to know when, why, and who was responsible for engaging or disengaging the switch of a theft deterrent device 104 and may customize the conditions under which notifications are sent to network device(s).

In some examples, a user may define the circumstances that the controller may cause a notification to be sent to one or more network devices, such as during a predetermined time frame (e.g., after work hours, during a weekend), an individual or set of individuals who caused the switch to be controlled (e.g., engaged or disengaged) (e.g., if a lower-level employee with fewer permissions disengages a switch), or otherwise.

In some examples, the theft deterrent device 104 may further comprise a manual override switch. The manual override switch may be configured to allow a user to connect or disconnect power supplied from the battery terminal of the vehicle to the powertrain of the vehicle. For purposes of clarity, the manual override switch is not depicted in the figures. In such examples, the controller may perform further operations comprising receiving via one or more of a transceiver or one or more sensor(s), a signal associated with a manual override. A user may, for example, cause a signal associated with a manual override to be received from a network device. In some examples, a user may use one or more communication protocols (e.g., Bluetooth, Zigbee, RFID, Wi-Fi) to attempt a manual override by verifying and/or authenticating themselves with one or more network devices.

For example, a user may, via an interface associated with a network device, use a two-factor authentication procedure (or similar) to authenticate themselves and to send a signal associated with a manual override. In other examples, one or more sensor(s) (e.g., inertial measurement unit (IMU), accelerometer, vibration sensor, tilt sensor, user input sensor, proximity sensor) may cause the controller to receive a signal associated with a manual override if, for example, a user presses a manual override button on the theft deterrent device 104. In some examples, the manual override switch may be a physical button on the theft deterrent device 104, which may be configured to allow a firefighter or other emergency personnel to control the switch to close the ignition circuit or interrupt the ignition circuit, thereby enabling or disabling the vehicle accordingly.

In other examples, the signal associated with a manual override may be received if one or more sensor(s) indicate that a potential thief has attempted to or is attempting to remove or otherwise disable or tamper with the theft deterrent device 104. In some examples, if a potential thief or other unauthorized user cuts the low current power supply lines 116, removes the theft deterrent device 104 without first deactivating or disabling it, or otherwise tampers with it, the theft deterrent device 104 may send a notification to one or more users alerting them of the tampering or removal.

In some instances, the theft deterrent device 104 may additionally or alternatively emit an audible alarm to ward off the potential thief and/or to draw attention to the tampering. The theft deterrent device 104 may, in some examples, remain in a current state for a predetermined duration (e.g., a default time-delay of 10 seconds or 10 minutes, a user-defined duration of 5 minutes). The theft deterrent device 104 may then subsequently control, based at least in part on the signal associated with the manual override, one or more of a switch disposed on the theft deterrent device 104 or a separate manual override switch to close the ignition circuit, thereby enabling the vehicle.

Additionally or alternatively, a proximity sensor or similar location-based sensor may cause the controller to receive a signal associated with a manual override based on a proximity of an authentication device (e.g., RFID tag, network device, key fob, etc.) or similar near-field communicator being within a threshold radius/proximity of the theft deterrent device 104. As a more concrete example, as a user approaches their car with a key fob or similar RFID tag, or if a user uses the near-field communication capabilities of a remote network device (e.g., a smartphone), one or more sensor(s) of the theft deterrent device 104 may detect the proximity and may determine, based at least in part on that proximity, that the remote network device is within a threshold distance and may accordingly send or otherwise cause the controller to receive a signal to close the circuit and enable the vehicle (e.g., via a manual override). In some examples, the controller may transmit, based at least in part on engaging the switch or receiving the manual override instruction, a notification (e.g., via a transceiver) to network device(s). As a more concrete example, the controller may send a notification to one or more network devices that the theft deterrent device 104 was manually overridden after work hours.

In some examples, a theft deterrent device 104 may further comprise an energy storage device that may serve as a backup or may otherwise supply power to the theft deterrent device 104 in the event that battery 102 does not (e.g., battery 102 becomes discharged, the low current power supply lines 116 are cut, etc.). In some examples, the energy storage device may be the primary source of energy to the theft deterrent device 104 and its associated components (e.g., an energy storage device may be responsible for implementing the processes and/or techniques via the controller(s) and transceiver(s)). In examples, the energy storage device may be electrically coupled to the controller and may be configured to provide power to the controller such that the controller can carry out any of the techniques discussed herein notwithstanding power supplied by the vehicle battery. For example, the energy storage device may provide power to the controller sufficient to control the switch to open the ignition circuit. In another example, the energy storage device may buffer or smooth out fluctuations in power demand or supply and/or may be configured to handle peak load(s) (e.g., provide extra or additional energy during a high demand moment or action to avoid damaging or adding stress to the vehicle battery).

In other examples, the theft deterrent device 104 may comprise a one or more sensor(s) (e.g., a location sensor (e.g., a global positioning satellite (GPS)), inertial measurement unit (IMU), accelerometer, vibration sensor, tilt sensor, user input sensor, proximity sensor, etc.), that the controller may use to send and/or receive information associated with the theft deterrent device 104. For example, a location sensor may be beneficial if a user wants to receive a notification in the event that a theft deterrent device 104 (and potentially the vehicle associated with the theft deterrent device 104) maneuvers outside of a predetermined geofence, or otherwise travels to or outside of a defined location. As a more concrete example, a user may define a set of one or more locations, such as car dealership lots, and may define notification criteria that the theft deterrent device 104 may use along with the location sensor to determine if/when a theft deterrent device 104 or associated vehicle maneuvers outside of one of the dealership lots and may cause notification to be transmitted to network device(s) accordingly.

In some implementations, the theft deterrent device 104 may, upon receiving a signal or data from a network device or from a backend service (e.g., cloud service), set a monitor component. A monitor component may determine if and when an event occurs, such as a user engaging the ignition circuit of a vehicle (thereby affecting a change in power to the ignition circuit of the vehicle). In some examples, the monitor may, upon detecting the event, disconnect a switch inline an ignition circuit of the vehicle or otherwise disconnect power supplied to a powertrain of the vehicle to disable the vehicle. In other words, rather than disconnecting the power supplied to the vehicle upon receipt of a disconnect instruction, the theft deterrent device 104 may instead set a monitor with certain parameters that may cause the theft deterrent device 104 to maintain a current state until one or more of the parameters is met (e.g., the device belongs to a collection, a surge in power/current supplied to the ignition circuit of a vehicle is detected, etc.). Such a feature allows the vehicle associated with the theft deterrent device 104 to remain in a nominal operational state until the monitor detects an event or condition that it is set to monitor for.

In another example, a theft deterrent device 104 may receive an instruction that comprises a plurality of signals. A first signal may indicate or instruct that the theft deterrent device 104 should maintain a current state of power supplied to a powertrain of a vehicle until an event has occurred or a threshold has been satisfied. For example, the theft deterrent device 104 may maintain a current state of power supplied to a powertrain of the vehicle (e.g., may set a monitor component) unless and until a change in power meets or exceeds a threshold change. The theft deterrent device 104 may additionally or alternatively receive a second signal to control a switch inline with the ignition circuit to disconnect power supplied to the powertrain if the change in power meets or exceeds a threshold change. For example, the theft deterrent device 104 may maintain a current state of power supplied to the powertrain of the vehicle and may, upon detection or determination that a change in power supplied meets or exceeds a threshold (e.g., a surge of power may indicate an attempt to start the vehicle or a drop off in power may indicate tampering with the vehicle and/or its components), control a switch inline with the ignition circuit such that the power supplied to the powertrain of the vehicle is disconnected (e.g., thereby disabling the vehicle).

Doing so may allow the various electronic components of a vehicle to receive power supplied by the power supply of the vehicle after the theft deterrent device 104 receives a signal or data. If and when the monitor component of the theft deterrent device 104 detects that a predefined event or condition has occurred or been satisfied, the theft deterrent device 104 may then control a switch or otherwise disconnect power supplied to the ignition circuit and/or powertrain of the vehicle, thereby disabling the vehicle.

FIG. 1B illustrates a related example scenario of a theft deterrent device 104 in the context of a battery 102. FIG. 1B illustrates the theft deterrent device 104 from a different perspective and depicts an additional or alternative embodiment of the theft deterrent device 104 and of the discussion herein.

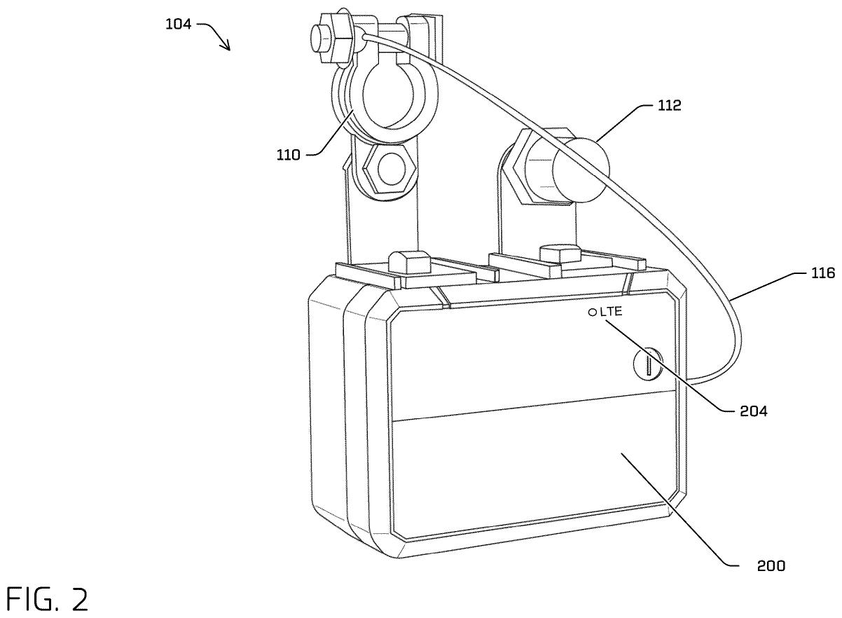

FIG. 2 illustrates an example of a theft deterrent device 104. As depicted, the theft deterrent device 104 may comprise a housing body 200 that may include one or more transceivers, one or more controllers, one or more sensors, one or more switches, and/or other components as discussed herein. The theft deterrent device 104 may comprise a first electrical connector 110 configured to couple to a negative post (e.g., negative terminal 108) of the battery 102 and a second electrical connector 112 to which a negative wire 114 of the ignition circuit may be connected.

In some examples, a switch may be coupled to the electrical connector 110 inline an ignition circuit. In such an example, the switch may be configured to selectively open and close the ignition circuit, thereby enabling the vehicle ignition when the ignition circuit is closed and disabling the vehicle ignition when the ignition circuit is open.

In some examples the housing body 200 of the theft deterrent device 104 may further comprise one or more indicators 204. The one or more indicators 204 may display, for example, a power supply status, a network connectivity status, an error status, a Bluetooth connectivity status, a component fault status, and so on. In some examples, the one or more indicators 204 may depict a voltage regulator that may signal to a user if and when the voltage of the power supply to which the theft deterrent device 104 is coupled is below a threshold voltage. Such data may additionally or alternatively be transmitted to one or more network devices to alert a user that a power supply voltage has fallen below a threshold voltage or may otherwise need service and/or maintenance. The examples of what one or more indicators 204 may depict as discussed above are presented for purposes of illustration and not limitation. One of ordinary skill in the art will understand and appreciate the myriad data, information, and/or context that may be displayed or presented by one or more indicators 204 on a housing body 200.

In some examples, the housing body 200 may additionally comprise a unique identifier (e.g., quick-response (QR) code, bar code, unique ID from a retrievable database). The unique identifier may be used to initialize, activate, transfer, or otherwise manipulate ownership of or access to a theft deterrent device 104. For example, a user or operator may install a theft deterrent device 104 according to the techniques discussed herein and may use a network device to scan or otherwise collect data associated with the unique identifier from the theft deterrent device 104 (e.g., using near-field communications technology) and may associate it with a particular vehicle. As a more concrete example, a car dealer may install a theft deterrent device 104 on a vehicle and may use the unique identifier associated with the theft deterrent device 104 to associate it with that vehicle. The vehicle may then be added to a fleet or inventory list associated with the car dealer.

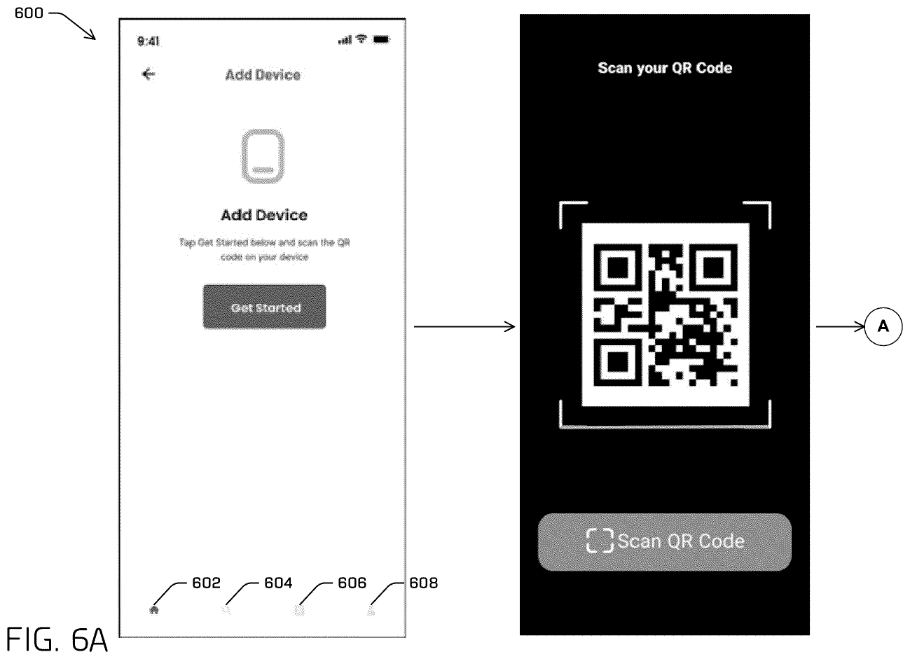

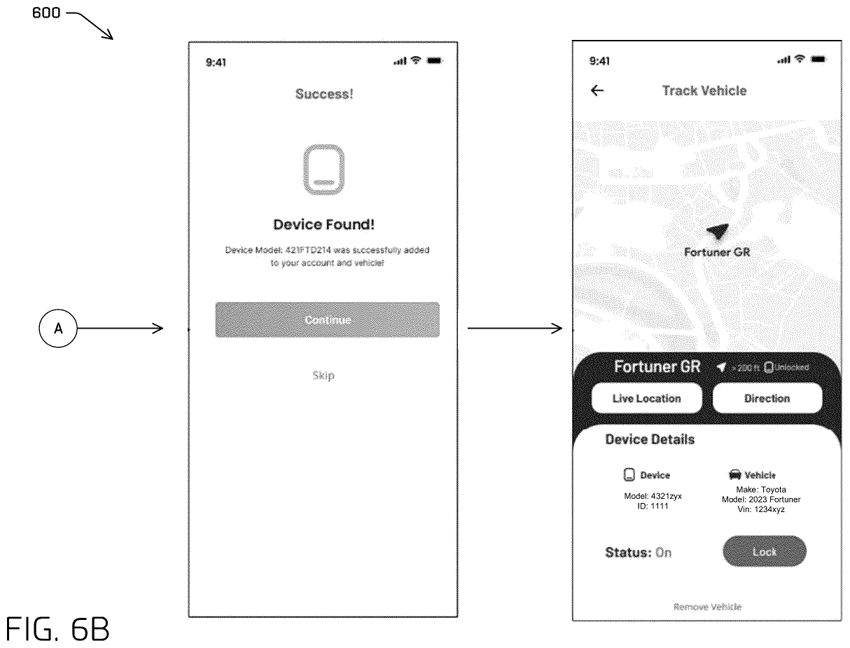

FIG. 6A and FIG. 6B depict an example process for adding a theft deterrent device 104 to a fleet of vehicles that may be owned and/or operated/managed by a user as may be presented by a smartphone application or similar network device application (e.g., on the user's network device).

As another concrete example, a user who purchases a vehicle from a car dealer may also purchase a theft deterrent device 104 that is coupled to the vehicle. In such an example, the user may scan the unique identifier and associate the theft deterrent device 104 with a subscription plan on a network device belonging to the user. In such an example, when the purchaser of the vehicle transfers the theft deterrent device 104's association to the network device belonging to and/or the subscription of the purchaser, such a process may subsequently or simultaneously remove the theft deterrent device 104 from the inventory list of the previous owner (e.g., a dealership and/or seller).

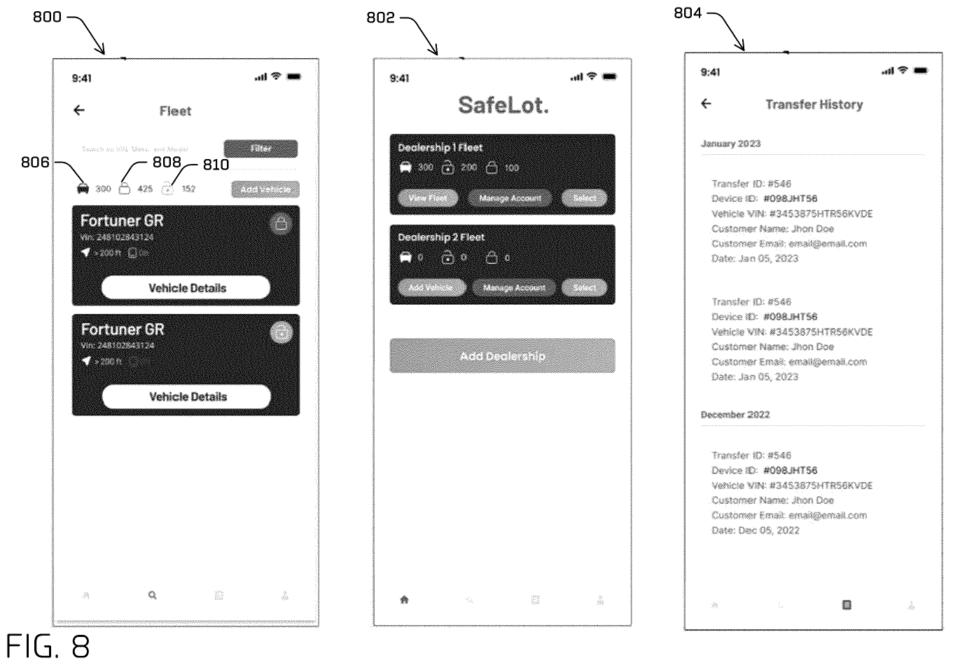

FIG. 8 depicts an example GUI that may display a transaction/transfer history of the theft deterrent device 104 and/or the vehicle that it is associated with. Such information may be used, for example, when a first dealership trades or swaps vehicles with a second dealership, and the associated theft deterrent devices 104 may log and/or save the transfer history for later use by an operator or dealer. In other examples, the transfer history may be used before, during, or after one or more sales/transactions occur with the theft deterrent device 104. In such an example, a buyer of a vehicle may wish to track the transfer history associated with the device to see how many previous individuals or companies have owned the vehicle, who those people/companies were, when those transfers took place, etc.

In some instances, the unique identifier that facilitates the transfer of ownership of a theft deterrent device may be accomplished via other communication means (e.g., email, near-field communications, etc.) or may be done manually with a network device and a unique code associated with the theft deterrent device 104. In such a situation, an additional layer of security (e.g., two-factor authentication, security question(s), etc.) may be leveraged to ensure a secure and valid transfer of ownership.

In some examples, various electronic components (e.g., transceiver(s), controller(s), sensor(s)) of the theft deterrent device 104 may be powered by the battery 102 (e.g., vehicle battery) via low current power supply lines 116. Additionally or alternatively, the theft deterrent device 104 may include a battery power supply (not shown in this figure) as either a primary or backup power supply.

### Example System

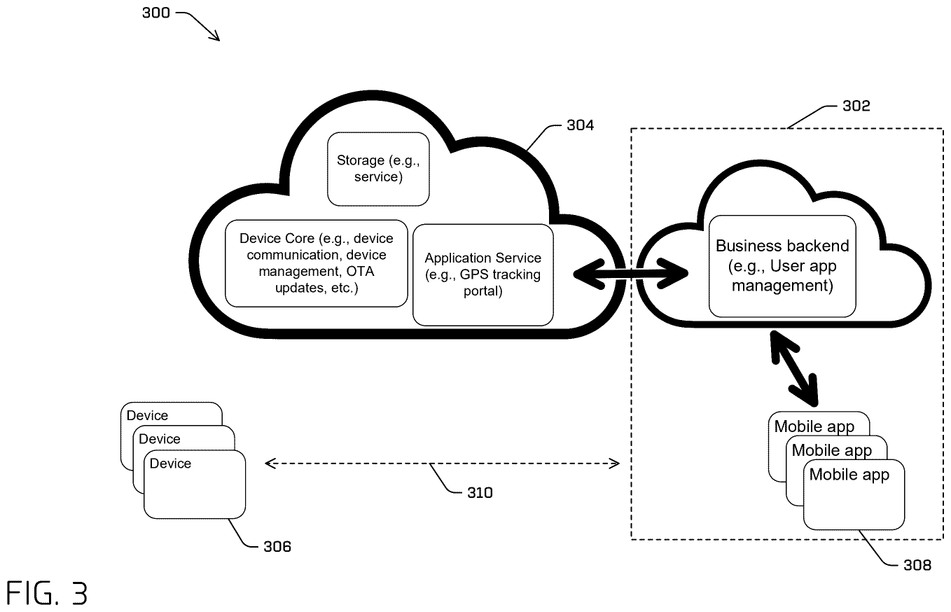

FIG. 3 depicts an example system 300 configured to implement one or more of the techniques of this disclosure. For purposes of clarity and not limitation, example system 300 depicts an application operating side 302 and a device operation side 304. The device operation side 304 may represent the functionality, processes, and components associated with one or more theft deterrent devices (e.g., device(s) 306). Each theft deterrent device 104 (e.g., each device of device(s) 306) may comprise an instance of device operation side 304 as depicted. The application operating side 302 may be configured to communicate with mobile app(s) that each may be associated with network device(s). That is, each instance of a mobile application of mobile app(s) 308 may be associated with network device(s) and may be configured to facilitate user interaction(s) and functionalities according to the techniques described herein. For example, mobile app(s) 308 may correspond to network device(s), which may be configured to implement or execute an instance of mobile app(s) 308.

Mobile app(s) 308 may comprise smartphone applications, web-based applications, or otherwise, and may be configured to access or communicate with one or more instances of a theft deterrent device 104. Mobile app(s) 308 may allow one or more users to execute the operations or procedures discussed herein (e.g., transmit a disconnect instruction to a plurality of theft deterrent device(s) to disable their respective vehicles).

As depicted, example system 300 may further comprise a device operation side 304. The device operation side 304 may represent the functionalities and components of any given theft deterrent device 104. The device operation side 304 may be at least partially responsible for facilitating communication (e.g., via transceiver(s)) between a theft deterrent device 104 and the application operating side 302. Although depicted as comprising a device core (e.g., a controller), a storage component, and an application service component, the device operation side 304 of any given theft deterrent device 104 may comprise myriad features, components, and functionalities discussed herein. A person of ordinary skill in the art will understand and appreciate the wide variety of components and features that may comprise a device operation side 304 associated with a theft deterrent device 104.

In some examples, example system 300 may comprise a communication protocol 310 (e.g., cellular network, Bluetooth, near field communication, RFID tag). The communication protocol 310 may facilitate communication between a theft deterrent device 104 and the application operating side 302. As discussed above, the communication protocol 310 may be determined by a network device. In some examples, the communication protocol may be static, meaning a theft deterrent device 104 is configured to use cellular data for all communications. In other examples, the communication protocol 310 may be dynamic, meaning it may be determined according to a number of conditions, principles, and/or preferences. In such an example, the communication protocol 310 may be determined just before transmitting or receiving data instead of having a predefined static communication protocol.

In some examples, a theft deterrent device 104 may communicate directly (e.g., peer-to-peer) with the application operating side 302. In other examples, a theft deterrent device 104 may communicate via one or remote computing resources (e.g., servers or computing resources configured to implement various techniques discussed). That is, a theft deterrent device 104 may be configured to transmit and receive data directly to/from an application operating side 302. Additionally or alternatively, a theft deterrent device 104 may be configured to transmit and receive data through a third-party or additional remote computing system (e.g., a theft deterrent device 104 may route data through a server or other relay component).

In some examples, any one or more of the processes and/or procedures may be executed at least in part by a remote computing resource (e.g., application operating side 302, a cloud computing device, a remotely accessible server). In such an example, the remote computing resource may store, maintain, and/or have access to (e.g., be communicatively coupled to) a retrievable database that comprises a list or inventory of theft deterrent devices (e.g., plurality of theft deterrent devices 104). For each theft deterrent device 104 stored in the retrievable database, the remote computing resource may also store or have access to information about the vehicle with which the theft deterrent device 104 is associated. For example, a remote computing resource may store or have access to the myriad vehicle attributes (e.g., a VIN number, manufacturer, year, model) associated with each vehicle and/or configuration attributes (e.g., time of day, day of the week, month, date) associated with the context or circumstances of each vehicle. In some examples, the vehicle attributes may be stored in association with a vehicle to which each theft deterrent device 104 is coupled, or in association with an identifier of a theft deterrent device 104 to improve the recall or retrieval of the vehicle attributes.

Additionally or alternatively, the remote computing resource may be configured to store or have access to each user(s)/entity(s) associated with an account that may host or comprise a plurality of theft deterrent devices. The remote computing resource may store or have access to the various level of permissions and/or authority for each participant or user. Additionally or alternatively, the remote computing resource may store of have access to geographical restraints (e.g., geofences) associated with theft deterrent devices (e.g., and their associated vehicle(s). In examples, the remote computing resource may store or have access to myriad other information that may be used by the system(s) herein or displayed to one or more users. In such an example, when a user sends an instruction or data from a network device, the remote computing resource may receive the instruction or data, interpret its' contents (e.g., user specified criterion), and determine which theft deterrent device(s) stored in the retrievable database are implicated by or satisfy the contents of the user's instructions or data. In other words, rather than a user specifying a fleet of vehicle(s) at a network device, the user may specify a condition(s) and/or criterion, where the remote computing resource may then interpret the criterion, determine a collection of vehicles and/or theft deterrent device(s) in the database that satisfy the criterion, and transmit the instruction or data to the collection of vehicles and/or theft deterrent device(s) accordingly. In at least some examples, a remote computing resource or system may comprise one or more processor(s) and non-transitory computer readable media storing processor-executable instructions that, when executed by the one or more processor(s), cause the one or more processor(s) to perform any of the operations or techniques discussed herein.

Additionally or alternatively, as discussed in more detail above, some or all of these functionalities or techniques may be transmitted to and implemented by individual theft deterrent device(s) (e.g., by a controller and related components on each theft deterrent device 104). In such examples, the theft deterrent device(s) may comprise one or more processor(s) and non-transitory computer readable media storing processor-executable instructions that, when executed by the one or more processor(s), cause the one or more processor(s) to perform any of the operations or techniques discussed herein.

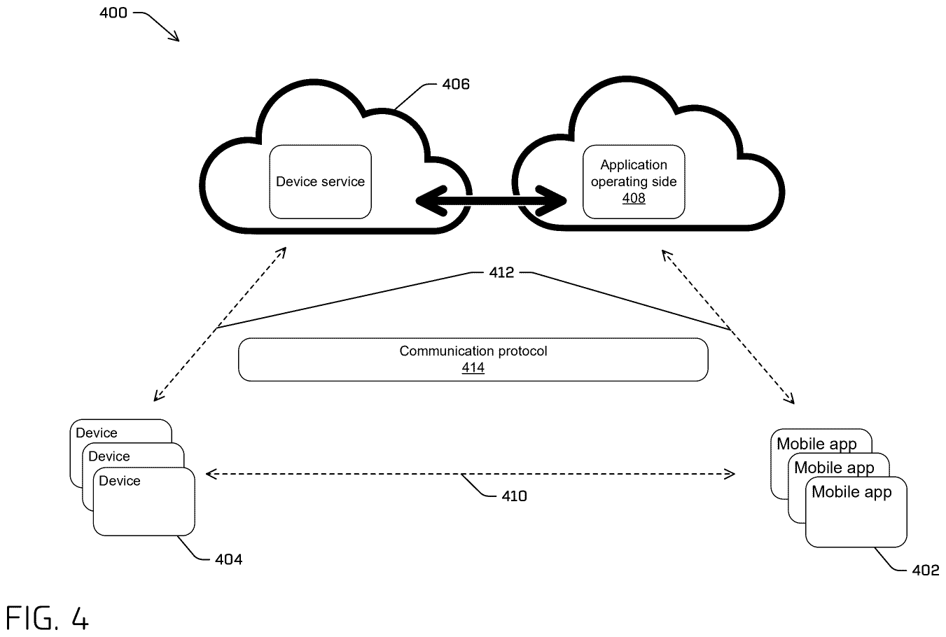

FIG. 4 depicts an example system 400 configured to implement one or more of the techniques of this disclosure. Example system 400 depicts mobile app(s) 402 (which may correspond to mobile app(s) 308). Mobile app(s) 402 may comprise or correspond to (e.g., operate on) network device(s), as discussed in more detail above.

Example system 400 may comprise device(s) 404 (which may correspond to device(s) 306). Device(s) 404 may be multiple instances of theft deterrent device 104. Device(s) 404 may communicate with or be associated with a device service 406. Device service 406 may be a traffic-shaping policy (TSP) basic service (TSP basic service).

In some examples, device service 406 may be communicatively coupled to an application operating side 408 (which may correspond to application operating side 302. Application operating side 408 and the device service 406 may be one or more distinct wireless networks (e.g., a backend server, cloud computing device, remote computing resource) or may comprise one wireless network service designed to facilitate communication between device(s) 404 (e.g., theft deterrent device 104) and mobile app(s) 402 (e.g., a single of what may be many communicatively coupled network device(s)).

A communication protocol 414 may be leveraged or employed to communicatively couple any one or more components of example system 400 with other components of example system 400. As depicted for purposes of clarity and not limitation, device(s) 404 may, as discussed above, be communicatively coupled directly to network device(s) via a peer-to-peer communication protocol 410. Communication protocol 414 (which may correspond to communication protocol 310) may inform how data is transmitted to the various components of example system 400. As discussed above, communication protocol 414 may be static or dynamic, and/or may comprise myriad different methods or processes capable of transmitting data from one device or computing resource to another.

Additionally or alternatively, device(s) 404 may communicate indirectly with the network device(s). For example, as illustrated, device(s) 404 and/or mobile app(s) 402 may communicate via the techniques discussed herein (e.g., one or more cellular networks 412, one or more Wi-Fi networks/routers) to send or otherwise transmit data and instructions to a remote computing resource component (e.g., a cloud service). A remote computing resource component may receive, interpret, translate, or otherwise act on the data/instructions and may transmit or relay the data/instructions to other components of example system 400. One of ordinary skill in the art will understand and appreciate that the myriad protocols and techniques that may be employed to transmit data from device(s) 404 to mobile app(s) 402 (e.g., either directly, through a cloud server or other remote computing resource, or any combination thereof).

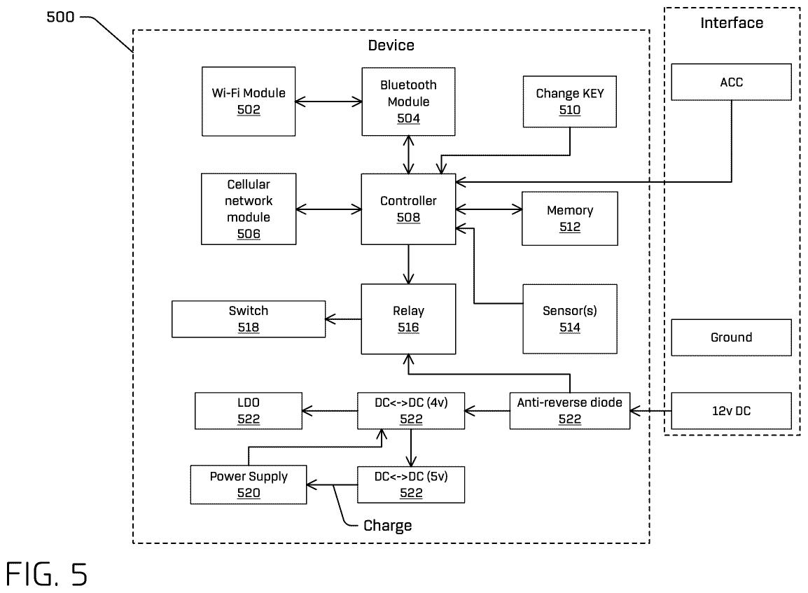

FIG. 5 illustrates a block diagram of an example device 500 (which may be an instance of theft deterrent device 104) configured to implement one or more of the techniques discussed herein.

Example device 500 may comprise a Wi-Fi module 502 that may be communicatively coupled to a Bluetooth module 504 and/or to a controller 508. The Wi-Fi module 502, cellular network module 506, and Bluetooth module 504, in addition to or in lieu of myriad other communication components, may individually or in combination interface with a controller 508 to facilitate transmission and reception of data.

In some examples, example device 500 may comprise a controller 508. Controller 508 may be configured to implement logical or control functionalities as example device 500. In examples, controller 508 may be responsible for processing and/or executing any one or more of the processes or operations discussed herein. For example, controller 508 may receive data or a signal from a change key 510 that may be associated with a manual override or manual instruction/signal. Change key 510 may, in some instances, allow a user/operator to manually alter the status of the theft deterrent device 104 (e.g., close or interrupt an ignition circuit in the event wireless communication techniques fail or are otherwise faulty or inoperable).

In some examples, controller 508 may comprise or be communicatively coupled to (e.g., at a remote computing resource) one or more processors and a memory 512. In examples, memory 512 may store non-transitory computer readable media storing processor-executable instructions that, when executed by the one or more processors, cause the one or more processors to perform any one or more of the operations discussed herein. In some examples, processor(s) of an example device 500 may comprise an application specific integrated circuit (ASIC), field programmable gate array (FPGA), microcontroller unit (MCU), system-on-chip (SoC), digital signal processor (DSP), or similar controller configured to carry out the processing and/or execution of one or more operations discussed herein.

In some examples, example device 500 may comprise one or more sensor(s) 514 (e.g., user input sensor (e.g., button(s)), proximity sensor, inertial measurement unit (IMU), accelerometer, vibration sensor, tilt sensor, location sensor). In examples, the sensor(s) may interface with controller 508 to implement one or more of the techniques herein (e.g., determine whether a theft deterrent device has been tampered with or removed).

Controller 508 may be at least in part responsible for causing communication with a relay 516 (e.g., magnetic latch relay, voltage relay (solenoid valve), electromechanical relay, solid-state relay). Relay 516 may be coupled to or associated with a switch 518. Switch 518 may be disposed inline an ignition circuit of a vehicle. Switch 518 may be configured to disconnect or otherwise interrupt an ignition circuit of a vehicle, thereby disabling the vehicle, as discussed in more detail above.

In some examples, various electronic components (e.g., transceiver, controller, sensors) of example device 500 may be powered by the battery 102 via low current power supply lines 116. In such examples, example device 500 may not comprise a separate power supply and may instead receive power from the battery 10 of the vehicle. In other examples, example device 500 may comprise a separate power supply (e.g., power supply 520), which may serve as either a primary power supply or a secondary (e.g., back up) power supply.

Example device 500 may additionally or alternatively comprise power circuit(s) 522. Power circuit(s) 522 as depicted are intended to be illustrative and in no way limiting or otherwise definitive of the myriad ways that power circuit(s) 522 may be coupled to any component(s) of the example device. As depicted for purposes of clarity and not limitation, power circuit(s) 522 may be disposed in the housing body 200 of example device 500. Power circuit(s) 522 may implement myriad functionalities. For example, power circuit(s) 522 may convert power from a source (e.g., battery 102, an onboard power supply), into appropriate voltage and current requirements for the various components of example device 500. For example, a four-volt DC to DC converter is depicted for purposes of illustration and not limitation. Also depicted is a five-volt DC to DC converter, which may be configured to supply a charge to power supply 520.

In other examples, power circuit(s) 522 may regulate voltage to maintain relatively stable and precise (e.g., within a threshold) voltage and current levels. In another example, power circuit(s) 522 may manage energy distribution to various parts or components of an example device 500 and may be configured to optimize power usage (e.g., to extend battery life, to limit battery usage or drain). In yet another example, power circuit(s) 522 may comprise protection or failsafe mechanisms configured to protect components of example device 500 from overcurrent, overvoltage, thermal inconsistencies or faults, and so on, to help prevent damage to example device 500 and its components due to electrical faults or surges. For example, power circuit(s) 522 may comprise an anti-reverse diode configured to prevent reverse current flow and protect the circuit(s) and component(s) from damage caused by incorrect or faulty power source(s). Power circuit(s) 522 may further comprise low-dropout regulators (LDOs) or switch-mode power supplies (SMPS) for improved energy efficiency and decreased energy consumption.

The components and examples discussed herein are for purposes of clarity and not limitation, and many more power circuit(s) 522 are contemplated herein. One of ordinary skill in the art will understand and appreciate the myriad energy-related features and functions that may be incorporated by power circuit(s) 522 in an example device 500 to increase the performance, reliability, safety, and efficiency of a theft deterrent device.

Example device 500 is not intended to be an exhaustive depiction of components and/or modules that may comprise a theft deterrent device 104. As an example, the manual override switch as discussed above is not depicted as part of the example device 500. There are numerous other components and/or modules that may be part of a theft deterrent device 104. One of ordinary skill in the art will understand and appreciate the various components that may be included in an example device 500 to provide different functionalities suitable for different implementations or circumstances.

FIGS. 6A and 6B depict an example process 600 configured to implement the techniques discussed herein. For example, FIGS. 6A and 6B may represent an example graphical user interface (GUI) as may be presented to a user on a network device. More specifically, FIGS. 6A and 6B may depict an instance of a mobile application as displayed to a user on a smartphone or tablet network device. Example process 600 may facilitate the association of a theft deterrent device 104 with a vehicle. Example process 600 may further facilitate the addition of the associated vehicle to a fleet of vehicles owned or operated by a user (e.g., an individual, a dealership). As depicted, the theft deterrent device 104 is associated with a vehicle using an identifier (QR code), and the vehicle attributes are then presented to the user via the GUI (e.g., location, make, model, device information, etc.). As depicted for purposes of clarity, the user may remotely “lock” the vehicle, which may correspond to disabling the vehicle by transmitting data to the associated theft deterrent device 104. The data may represent or comprise a signal configured to cause the theft deterrent device 104 to control a switch and interrupt an ignition circuit to disable the vehicle. For example, the theft deterrent device 104 associated with the vehicle may receive a signal associated with a disconnect instruction and may (e.g., via a controller 508) control a relay 516 and/or switch 518 to interrupt the ignition circuit.

In at least some examples, the example GUI may comprise a plurality of elements that facilitate user interaction and which may be configured to implement one or more of the techniques discusses herein. For example, a first element 602 may allow a user to navigate to a home page, where they may be able to view or modify a fleet of vehicle(s) (e.g., add a vehicle according to example process 600). A second element 604 may allow a user to search for a specific theft deterrent device and/or vehicle, and to view or modify information associated with the specific theft deterrent device and/or its associated vehicle. A third element 606 may be configured to allow a user to view an inventory of vehicle(s) and/or theft deterrent device(s). A fourth element 608 may allow a user to navigate to their profile, where they may be able to sign out, adjust settings, manipulate or modify their designs/preferences, and so on. The elements depicted and described are for purposes of illustration and not limitation, and many more are contemplated herein.

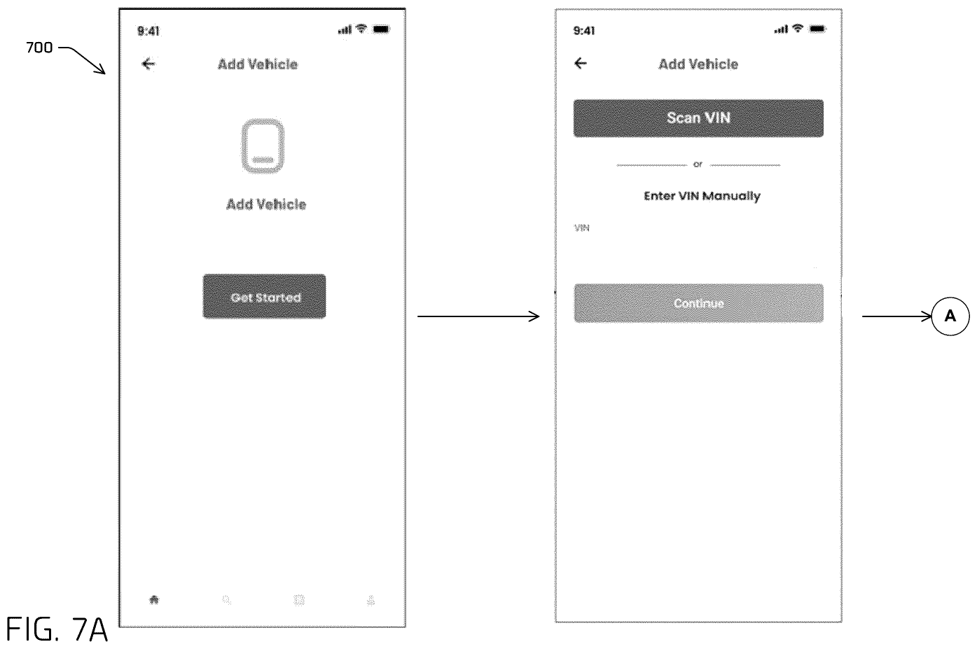

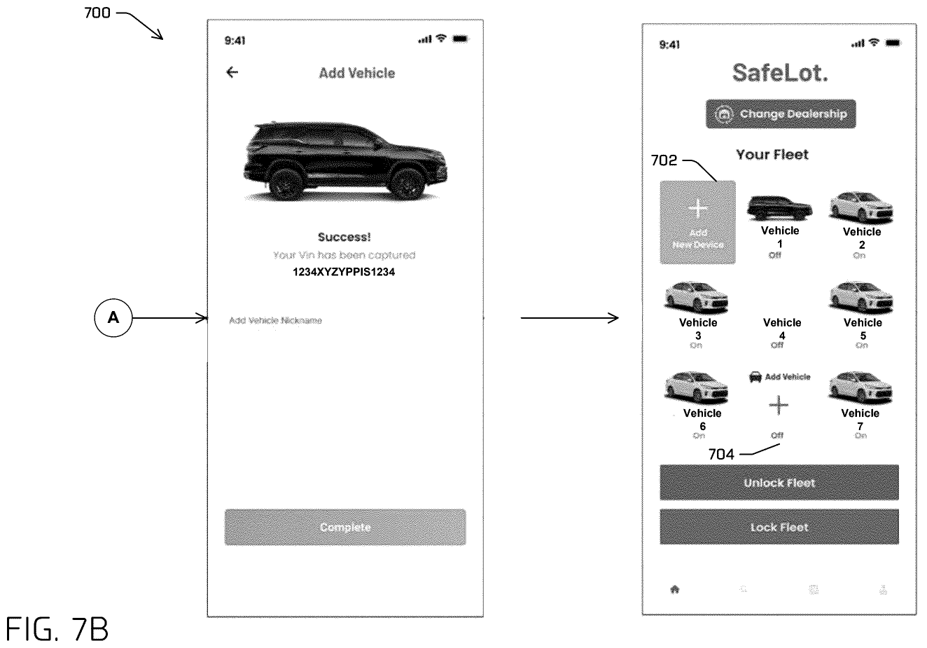

FIG. 7A and FIG. 7B depict an example process 700 configured to implement one or more of the techniques discussed herein. Example process 700 may facilitate the addition of a vehicle to a fleet of vehicle(s) as may be presented to a user via a GUI. In some examples, a user may add a vehicle to a fleet of vehicle(s), which may cause each vehicle's corresponding theft deterrent device(s) to be added to an inventory or fleet. In some examples, a user may add theft deterrent device(s) to an inventory/list using techniques similar to example process 600. Doing so may implicate vehicle(s) associated with each theft deterrent device, which may cause each vehicle to be added to a fleet. In other examples, a user may add vehicle(s) to a fleet of vehicles using techniques similar to example process 700. Doing so may implicate theft deterrent device(s) associated with each vehicle, which may cause each theft deterrent device to be added to a list or fleet inventory. As depicted for purposes of clarity and not limitation, a user may configure a fleet (e.g., collection or subset) of vehicles according to criterion (e.g., one or more user-specified criterion), and the techniques discussed may determine which vehicle(s) as associated with vehicle attributes that satisfy the criterion. The user may then disable the fleet (collection) of vehicles remotely using a “lock fleet” button or similar component. In another example, the user may define conditions or factors that cause a collection of vehicle(s) to be added (e.g., time of day, location, etc.).

In some examples, the GUI depicted by FIG. 7B may depict a number of elements configured to allow user interaction. The elements may be configured to implement one or more of the techniques discussed herein. For example, a first element 702 may allow a user to add a new device to an inventory of device(s). Such may be the case where the user has a new (e.g., purchased or transferred) theft deterrent device that is not yet associated with a vehicle, but that they wish to include in their inventory of theft deterrent device(s). For example, the first element 702 may be configured to implement one or more techniques discussed above with regard to example process 600. A second element 704 may allow a user to add a vehicle to a fleet of vehicle(s) owned or operated by the user. For example, the second element 704 may be configured to implement one or more techniques discussed with regard to example process 700.

FIG. 8 depicts an example GUIs (e.g., example GUI 800, example GUI 802, example GUI 804) to view vehicle fleet-related metrics or information. The depicted example GUIs may represent instances of an application for a network device (e.g., smartphone or other mobile device, personal computer, and so on).

Example GUI 800 may present to a user various information and data associated with vehicle(s) that it owns or operates (or, e.g., has authority to view/modify). Example GUI 802 may allow a user to view/manage more than one fleet of vehicles. Such may be the case where a user owns multiple lots of vehicles. For example, a regional manager may be responsible for two or more dealerships in the region, each of which may own or operate (or have control over) multiple fleets/collections of vehicles. Example GUI 804 depicts an example transfer history. For example, the example transfer history may be associated with a theft deterrent device that is coupled to a vehicle, and the example transfer history may log, store, or present the transfer history of the vehicle. For example, when a first user sells their vehicle to a second user, ownership of a theft deterrent device 104 associated with their vehicle may also transfer. In such an example, the example transfer history may depict information related to the transfer of the vehicle as well as the transfer of the theft deterrent device 104.

As depicted for purposes of illustration and not limitation, example GUI 800 comprises a plurality of elements (e.g., element 806, element 808, clement 810). Element 806 may present, to the user, the quantity of vehicles in a fleet owned or operated by the user. The first element 806 may change if, for example, the user modifies the number of vehicles in their fleet (e.g. by trading/swapping cars with another dealer or by selling a vehicle to a customer), or if the user filters the vehicle(s) that they are currently viewing on example GUI 800. A second element 808 may depict the quantity of vehicles that are currently disabled (e.g., by activating a switch of each theft deterrent device to disrupt the ignition circuit and disconnect power supplied to a powertrain of corresponding vehicles) and/or that have a monitor set (e.g., to monitor for changes in power supplied to the powertrain of a vehicle). The second element 808 may also be configured to allow a user to tap or interact with second element 808 to disables en masse. For example, by tapping the second element 808, the user may cause to be transmitted a disconnect instruction to all vehicles in their fleet and/or to all vehicles that the user is currently viewing via example GUI 800. A third element 810 may depict the quantity of vehicles in the fleet of vehicles that are enabled (e.g., the ignition circuit of each vehicle is closed). The elements depicted by example GUI 800 are intended to be illustrative rather than limiting, and one or ordinary skill in the art will understand and appreciate the myriad elements that may be presented to a user via a graphical interface, each of which may be responsible for implementing, or may itself implement, at least some of the techniques discussed herein.

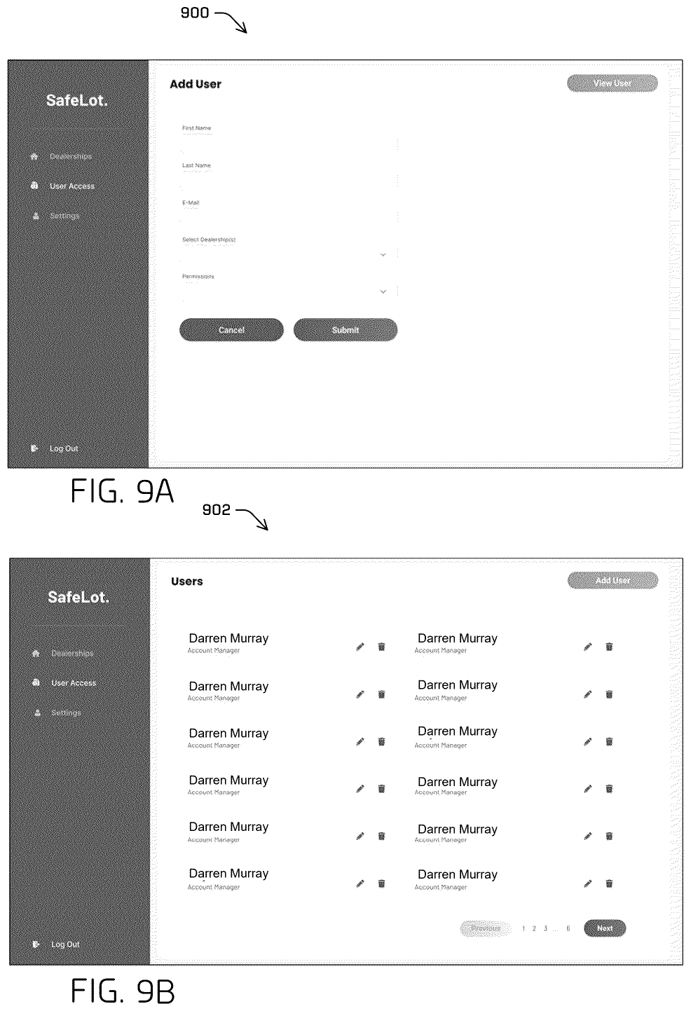

FIG. 9A and FIG. 9B depict example interfaces configured to facilitate one or more of the techniques herein. For example, FIGS. 9A and 9B may depict the addition or modification of user(s) associated with an account or entity. Example GUI 900 may facilitate the addition of a user to an existing account or entity (e.g., a dealership, a family). Example GUI 902 may depict information and data associated with existing user(s) associated with an account or entity. For example, example GUI 902 may depict all users associated with a dealership, each of which may have a determined level of permissions or authority. In such an example, a master or primary account may hold the greatest authority and may be capable of adding users, removing users, and/or modifying information associated with user(s) (e.g., permissions).

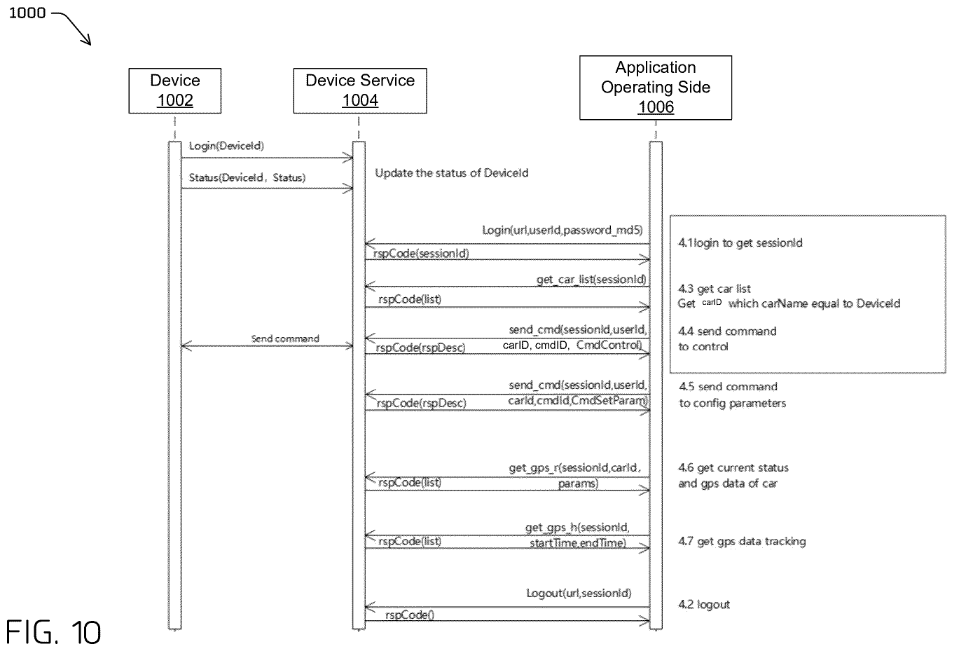

FIG. 10 depicts an example signal flow diagram 1000 configured to implement one or more of the techniques discussed herein. In some examples, device 1002 may correspond to a single or a plurality of theft deterrent device 104. In some examples, device service 1004 may correspond to device service 406 and/or device operation side 304. Device service 1004 may be configured to facilitate communication between theft deterrent device(s) with application operating side 1006 (which may correspond to application operating side 408 and/or application operating side 302). As discussed above, the application operating side 1006 and the device service 1004 may be communicatively coupled via a wireless network (e.g., a backend server or cloud computing device).

### Example Clauses

A: A device, comprising: an electrical connector configured to couple to a negative terminal of a vehicle battery, the vehicle battery associated with a vehicle; a switch coupled to the electrical connector and inline in an ignition circuit, the switch being configured to selectively open and close the ignition circuit; a transceiver; and a controller configured to cause the device to perform operations comprising: receiving, via the transceiver, a signal to control the switch; and controlling, based at least in part on the signal, the switch to open the ignition circuit so that the vehicle is disabled.

B: The device of paragraph A, further comprising a supply wire coupled to the vehicle battery and configured to supply power to the device.

C: The device of paragraph A or B, wherein the electrical connector is a first electrical connector, the device further comprising a second electrical connector connected to a negative wire of the ignition circuit.

D: The device of any of paragraphs A-C, the operations further comprising: receiving, via the transceiver, criteria data associated with a collection of one or more vehicles; receiving, via the transceiver, data associated with one or more vehicle attributes; determining, based at least in part on the criteria data and the data associated with one or more vehicle attributes, that the device is coupled to a vehicle belonging to the collection of one or more vehicles; and controlling the switch to close the ignition circuit to enable the vehicle based at least in part on determining that the device is coupled to the vehicle belonging to the collection of one or more vehicles.

E: The device of any of paragraphs A-D, wherein the data associated with one or more vehicle attributes comprises at least one of: a geolocation; a manufacturer of the vehicle; a model of the vehicle; a model year of the vehicle; or a vehicle identifier.

F: The device of any of paragraphs A-E, wherein the criteria data comprises at least one of a date or a time of day.

G: The device of any of paragraphs A-F, the operations further comprising receiving, via the transceiver, a signal to control the switch to close the ignition circuit so that the vehicle is enabled; controlling, based at least in part on the signal, the switch to close the ignition circuit to enable the vehicle; and sending, via the transceiver, a notification to one or more remote network devices indicating that the switch was controlled to close the ignition circuit.

H: The device of any of paragraphs A-G, further comprising one or more sensors comprising at least one of: a location sensor; an inertial measurement unit (IMU); an accelerometer; a vibration sensor; a tilt sensor; a user input sensor; or a proximity sensor.

I: The device of any of paragraphs A-H, further comprising a manual override switch configured to allow a user to open or close the ignition circuit of the vehicle.

J: The device of any of paragraphs A-I, the operations further comprising: receiving, via the transceiver or one or more sensors of the device, a signal associated with the manual override switch; maintaining the switch in a current state for a predetermined duration; and engaging, based at least in part on the signal, the manual override switch to close the ignition circuit so that the vehicle is enabled.

K: The device of any of paragraphs A-J, further comprising transmitting, via the transceiver and based at least in part on engaging the manual override switch, a notification to one or more users indicating that the manual override switch was engaged.

L: The device of any of paragraphs A-K, further comprising an energy storage device electrically coupled to the controller, the energy storage device configured to provide power to control the switch to open the ignition circuit.

M: The device of any of paragraphs A-L, wherein the electrical connector is configured to maintain power supplied by the device to electrical components of the vehicle, the operations further comprising: setting, based at least in part on the signal, a monitor configured to detect changes in the power supplied to the ignition circuit.

N: The device of any of paragraphs A-M, the operations further comprising: detecting, based at least in part on the monitor, an increase in power supplied to the ignition circuit, wherein controlling the switch to open the ignition circuit so that the vehicle is disabled is further based at least in part on detecting the increase in power supplied to the ignition circuit.

O: The techniques of any of paragraphs A-N, further comprising: method for controlling power supplied to a vehicle comprising: receiving, via a transceiver associated with a power supply control device coupled to the vehicle, a signal associated with engaging a switch inline an ignition circuit of the vehicle; and controlling, based at least in part on the signal, the switch to open the ignition circuit to disable the vehicle.

P: The techniques of any of paragraphs A-O, further comprising transmitting, via the transceiver, a notification to one or more network devices indicating that the switch was engaged to open the ignition circuit.

Q: The techniques of any of paragraphs A-P, further comprising: receiving, via the transceiver, criteria data associated with a collection of one or more vehicles; receiving, via the transceiver, data associated with one or more vehicle attributes; and determining, based at least in part on the criteria data and the data associated with one or more vehicle attributes, that the switch is coupled to the ignition circuit of a vehicle that belongs to the collection of one or more vehicles.

R: The techniques of any of paragraphs A-Q, wherein the power supply control device comprises an electrical connector configured to maintain power supplied to the power supply control device, the method further comprising: setting, based at least in part on the signal, a monitor configured to detect changes in the power supplied to the ignition circuit.

S: The techniques of any of paragraphs A-R, further comprising: a device comprising one or more processors and memory storing processor-executable instructions that, when executed by the one or more processors, cause the one or more processors to perform operations comprising: receiving, via a transceiver associated with a power supply control device coupled to a vehicle, a signal associated with engaging a switch inline an ignition circuit of the vehicle; and controlling, based at least in part on the signal, the switch to open the ignition circuit to disable the vehicle.

T: The techniques of any of paragraphs A-S, wherein the power supply control device comprises an electrical connector configured to maintain power supplied to the power supply control device, the operations further comprising: setting, based at least in part on the signal, a monitor configured to detect changes in the power supplied to the ignition circuit.

U: The techniques of any of paragraphs A-T, further comprising: a system comprising: one or more processors; and non-transitory computer readable media storing processor-executable instructions that, when executed by the one or more processors, cause the one or more processors to perform operations comprising: receiving, at a remote computing resource and from a network device, data associated with an instruction to monitor ignition circuits of multiple individual vehicles in a collection of vehicles; determining, by the remote computing resource and based at least in part on the data, criterion indicative of which individual vehicles to monitor; determining, by the remote computing resource, that a vehicle attribute associated with a vehicle satisfies the criterion; determining, by the remote computing resource and based at least in part on determining that the vehicle attribute satisfies the criterion, that the vehicle belongs to the collection of vehicles; and transmitting, based at least in part on determining that the vehicle belongs to the collection of vehicles, the instruction to a device disposed inline with an ignition circuit of the vehicle, the device configured to monitor the ignition circuit of the vehicle.

V: The techniques of any of paragraphs A-U, wherein the instruction comprises a signal to control a switch inline with the ignition circuit of the vehicle to disconnect power supplied to a powertrain of the vehicle.

W: The techniques of any of paragraphs A-V, wherein the instruction comprises: a first signal to maintain a current state of power supplied to a powertrain of the vehicle until a change in power supplied to the ignition circuit of the vehicle is detected; and a second signal to control a switch inline with the ignition circuit to disconnect power supplied to the powertrain if the change in power meets or exceeds a threshold change.

X: The techniques of any of paragraphs A-W, the operations further comprising: determining, by the remote computing resource, that a second vehicle attribute associated with a second vehicle satisfies the criterion; determining, by the remote computing resource and based at least in part on determining that the second vehicle attribute satisfies the criterion, that the second vehicle belongs to the collection of vehicles; and transmitting, based at least in part on determining that the second vehicle belongs to the collection of vehicles, the instruction to a second device disposed inline with a second ignition circuit of the second vehicle, the second device configured to monitor the second ignition circuit of the second vehicle

Y: The techniques of any of paragraphs A-X, wherein the criterion comprises at least one of: a geographical radius, a time of day, a manufacturer, a model, a model year or range of years, a vehicle identifier, a selection or indication of the collection of vehicles, a timeframe, a geolocation, or a price or range of prices.

Z: The techniques of any of paragraphs A-Y, further comprising: one or more non-transitory computer readable media storing processor-executable instructions that, when executed by one or more processors, cause the one or more processors to perform operations comprising: receiving criteria data associated with an instruction to monitor an ignition circuit of a vehicle; determining, based at least in part on the criteria data and a vehicle attribute associated with a vehicle, that the vehicle satisfies the criteria data; and transmitting, based at least in part on determining that the vehicle satisfies the criteria data, the instruction to a device disposed inline with an ignition circuit of the vehicle, the device configured to monitor the ignition circuit of the vehicle.

AA: The techniques of any of paragraphs A-Z, wherein the instruction comprises a signal to control a switch inline with the ignition circuit of the vehicle to disconnect power supplied to a powertrain of the vehicle.

AB: The techniques of any of paragraphs A-AA, wherein the instruction comprises: a first signal to maintain a current state of power supplied to a powertrain of the vehicle until a change in power supplied to the ignition circuit of the vehicle is detected; and a second signal to control a switch inline with the ignition circuit to disconnect power supplied to the powertrain if the change in power meets or exceeds a threshold change.

AC: The techniques of any of paragraphs A-AB, the operations further comprising: receiving authentication data associated with a user, and wherein transmitting the instruction to the device is further based at least in part on authenticating, based at least in part on the authentication data, the user.

AD: The techniques of any of paragraphs A-AC, the operations further comprising determining a communication protocol, and wherein the instruction is transmitted to the device via the communication protocol.

AE: The techniques of any of paragraphs A-AD, wherein determining a communication protocol is based at least in part at least one of: a distance between the vehicle and a network device from which the instruction was received; a communication latency; a network connectivity status of the vehicle and the network device; a user subscription status; or a preference setting.

AF: The techniques of any of paragraphs A-AE, wherein the communication protocol comprises at least one of: Bluetooth; cellular; wireless fidelity (Wi-Fi); a radio frequency protocol; or an ultrasonic communication frequency.

AG: The techniques of any of paragraphs A-AF, the operations further comprising receiving a notification, the notification indicating: that the device disposed inline with the ignition circuit of the vehicle was tampered with, or that a switch associated with the device configured to disconnect power supplied to a powertrain of the vehicle was activated.

AH: The techniques of any of paragraphs A-AG, wherein transmitting the instruction to the device is further based at least in part on receiving an indication that a manual override switch associated with the device was activated.

AI: The techniques of any of paragraphs A-AG, further comprising: a method comprising: receiving criteria data associated with an instruction to monitor an ignition circuit of a vehicle; determining, based at least in part on the criteria data and a vehicle attribute associated with a vehicle, that the vehicle satisfies the criteria data; and transmitting, based at least in part on determining that the vehicle satisfies the criteria data, the instruction to a device disposed inline with an ignition circuit of the vehicle, the device configured to monitor the ignition circuit of the vehicle.

AJ: The techniques of any of paragraphs A-AI, wherein the instruction comprises a signal to control a switch inline with the ignition circuit of the vehicle to disconnect power supplied to a powertrain of the vehicle.

AK: The techniques of any of paragraphs A-AJ, wherein the instruction comprises: a first signal to maintain a current state of power supplied to a powertrain of the vehicle until a change in power supplied to the ignition circuit of the vehicle is detected; and a second signal to control a switch inline with the ignition circuit to disconnect power supplied to the powertrain if the change in power meets or exceeds a threshold change.

AL: The techniques of any of paragraphs A-AK, further comprising: receiving authentication data associated with a user, and wherein transmitting the instruction to the device is further based at least in part on authenticating, based at least in part on the authentication data, the user.

AM: The techniques of any of paragraphs A-AL, further comprising receiving a notification, the notification indicating: that the device disposed inline with the ignition circuit of the vehicle was tampered with, or that a switch associated with the device configured to disconnect power supplied to a powertrain of the vehicle was activated.

AN: The techniques of any of paragraphs A-AN, wherein transmitting the instruction to the device is further based at least in part on receiving an indication that a manual override switch associated with the device was activated.

It is understood that any one or more of the preceding paragraphs may depend from, or may function with, any one or more other preceding paragraphs. Additionally or alternatively, it is understood that any one or more of the system, method, and/or device paragraphs recited herein may be employed in conjunction with, or in lieu of, any one or more other system, method, and/or device paragraphs.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
non-transitory computer readable media storing processor-executable instructions that, when executed by the one or more processors, cause the one or more processors to perform operations comprising:
receiving, at a remote computing resource and from a network device, data associated with an instruction to monitor ignition circuits of multiple individual vehicles in a collection of vehicles;
determining, by the remote computing resource and based at least in part on the data, criterion indicative of which individual vehicles to monitor;
determining, by the remote computing resource, that a vehicle attribute associated with a vehicle satisfies the criterion;
determining, by the remote computing resource and based at least in part on determining that the vehicle attribute satisfies the criterion, that the vehicle belongs to the collection of vehicles; and
transmitting, based at least in part on determining that the vehicle belongs to the collection of vehicles, the instruction to a device disposed inline with an ignition circuit of the vehicle, the device configured to monitor the ignition circuit of the vehicle.

2. The system of claim 1, wherein the instruction comprises a signal to control a switch inline with the ignition circuit of the vehicle to disconnect power supplied to a powertrain of the vehicle.

3. The system of claim 1, wherein the instruction comprises:
a first signal to maintain a current state of power supplied to a powertrain of the vehicle until a change in power supplied to the ignition circuit of the vehicle is detected; and
a second signal to control a switch inline with the ignition circuit to disconnect power supplied to the powertrain if the change in power meets or exceeds a threshold change.

4. The system of claim 1, the operations further comprising:
determining, by the remote computing resource, that a second vehicle attribute associated with a second vehicle satisfies the criterion;
determining, by the remote computing resource and based at least in part on determining that the second vehicle attribute satisfies the criterion, that the second vehicle belongs to the collection of vehicles; and
transmitting, based at least in part on determining that the second vehicle belongs to the collection of vehicles, the instruction to a second device disposed inline with a second ignition circuit of the second vehicle, the second device configured to monitor the second ignition circuit of the second vehicle.

5. The system of claim 1, wherein the criterion comprises at least one of:
a geographical radius,
a time of day,
a manufacturer,
a model,
a model year or range of years,
a vehicle identifier,
a selection or indication of the collection of vehicles,
a timeframe,
a geolocation, or
a price or range of prices.

6. Non-transitory computer readable media storing processor-executable instructions that, when executed by one or more processors, cause the one or more processors to perform operations comprising:
receiving criteria data associated with an instruction to monitor an ignition circuit of a vehicle;
determining, based at least in part on the criteria data and a vehicle attribute associated with a vehicle, that the vehicle satisfies the criteria data; and
transmitting, based at least in part on determining that the vehicle satisfies the criteria data, the instruction to a device disposed inline with an ignition circuit of the vehicle, the device configured to monitor the ignition circuit of the vehicle.

7. The non-transitory computer readable media of claim 6, wherein the instruction comprises a signal to control a switch inline with the ignition circuit of the vehicle to disconnect power supplied to a powertrain of the vehicle.

8. The non-transitory computer readable media of claim 6, wherein the instruction comprises:
a first signal to maintain a current state of power supplied to a powertrain of the vehicle until a change in power supplied to the ignition circuit of the vehicle is detected; and
a second signal to control a switch inline with the ignition circuit to disconnect power supplied to the powertrain if the change in power meets or exceeds a threshold change.

9. The non-transitory computer readable media of claim 6, the operations further comprising:
receiving authentication data associated with a user, and wherein transmitting the instruction to the device is further based at least in part on authenticating, based at least in part on the authentication data, the user.

10. The non-transitory computer readable media of claim 6, the operations further comprising determining a communication protocol, and wherein the instruction is transmitted to the device via the communication protocol.

11. The non-transitory computer readable media of claim 10, wherein determining a communication protocol is based at least in part at least one of:
a distance between the vehicle and a network device from which the instruction was received;
a communication latency;
a network connectivity status of the vehicle and the network device;
a user subscription status; or
a preference setting.

12. The non-transitory computer readable media of claim 11, wherein the communication protocol comprises at least one of:
Bluetooth;
cellular;
wireless fidelity (Wi-Fi);
a radio frequency protocol; or
an ultrasonic communication frequency.

13. The non-transitory computer readable media of claim 6, the operations further comprising receiving a notification, the notification indicating:
that the device disposed inline with the ignition circuit of the vehicle was tampered with, or
that a switch associated with the device configured to disconnect power supplied to a powertrain of the vehicle was activated.

14. The non-transitory computer readable media of claim 6, wherein transmitting the instruction to the device is further based at least in part on receiving an indication that a manual override switch associated with the device was activated.

15. A method comprising:
receiving criteria data associated with an instruction to monitor an ignition circuit of a vehicle;
determining, based at least in part on the criteria data and a vehicle attribute associated with a vehicle, that the vehicle satisfies the criteria data; and
transmitting, based at least in part on determining that the vehicle satisfies the criteria data, the instruction to a device disposed inline with an ignition circuit of the vehicle, the device configured to monitor the ignition circuit of the vehicle.

16. The method of claim 15, wherein the instruction comprises a signal to control a switch inline with the ignition circuit of the vehicle to disconnect power supplied to a powertrain of the vehicle.

17. The method of claim 15, wherein the instruction comprises:
a first signal to maintain a current state of power supplied to a powertrain of the vehicle until a change in power supplied to the ignition circuit of the vehicle is detected; and
a second signal to control a switch inline with the ignition circuit to disconnect power supplied to the powertrain if the change in power meets or exceeds a threshold change.

18. The method of claim 15, further comprising:
receiving authentication data associated with a user, and wherein transmitting the instruction to the device is further based at least in part on authenticating, based at least in part on the authentication data, the user.

19. The method of claim 15, further comprising receiving a notification, the notification indicating:
that the device disposed inline with the ignition circuit of the vehicle was tampered with, or
that a switch associated with the device configured to disconnect power supplied to a powertrain of the vehicle was activated.

20. The method of claim 15, wherein transmitting the instruction to the device is further based at least in part on receiving an indication that a manual override switch associated with the device was activated.
